(19) United States
(12) Patent Application Publication
(10) Pub. No.: US 2012/0186579 A1
(43) Pub. Date: Jul. 26, 2012

(54) Components and solar energy collection system

(75) Inventors: Kip H. Dopp, Newcastle, WY (US); Darren T. Kimura, Mililani, HI (US); Tommy Douglas Hindmarsh, Portland, OR (US)

(73) Assignee: Sopogy, Inc., Honolulu, HI (US)

(21) Appl. No.: 13/374,670

(22) Filed: Jan. 6, 2012

Related U.S. Application Data
(60) Provisional application No. 61/430,334, filed on Jan. 6, 2011.
(60) Provisional application No. 61/430,308, filed on Jan. 6, 2011.
(60) Provisional application No. 61/430,950, filed on Jan. 7, 2011.

(51) Int. Cl. F24J 2/10; G02B 7/183

(52) U.S. Cl. 126/684; 29/890.033

(57) ABSTRACT

Scalable arm assemblies for solar energy collector. In one instance, two end arms of two collectors are formed with identical hubs, end fittings, and bottom fitting but different connectors between hubs and fittings. Separate solar energy collector panels or wings may be interconnected with e.g. an interconnect that is asymmetric in one direction but symmetric in a second direction in cross-section. A solar energy collector may also have a unique sprocket drive system.

### CROSS REFERENCES TO RELATED APPLICATIONS

This application claims the benefit of priority to: U.S. App. Ser. No. 61/430,334 filed Jan. 6, 2011 and entitled “Scalable Arms,” inventors Kip H. Dopp, Darren T. Kimura, and Tom Hindmarsh; U.S. App. Ser. No. 61/430,308 filed Jan. 6, 2011 and entitled “Interconnect”, inventors Kip H. Dopp and Darren T. Kimura; and U.S. App. Ser. No. 61/430,950 filed Jan. 7, 2011, inventors Kip H. Dopp, Darren T. Kimura, and Tom Hindmarsh, all of which applications are incorporated by reference in their entirety as if put forth fully below.

This application also incorporates by reference the following patent applications that are referred to elsewhere in the text in their entirety as if put forth in full below: U.S. application Ser. No. 11/811,329 (filed Jun. 8, 2007) “Mirror Assemblies for Concentrating Solar Energy”; U.S. application Ser. No. 11/811,109 (filed Jun. 8, 2007) “Use of Brackets and Rails in Concentrating Solar Energy Collectors”; U.S. application Ser. No. 11/811,027 (filed Jun. 8, 2007) “Protecting Solar Energy Collectors from Inclement Weather”; U.S. application Ser. No. 11/811,073 (filed Jun. 8, 2007) “Use of Identical Components in Solar Energy Collectors”; U.S. application Ser. No. 11/811,153 (filed Jun. 8, 2007) “Support of Heat Collectors in Solar Energy Collectors”; PCT App. No. PCT/US2007/013618 (filed Jun. 8, 2007) “Apparatus and Methods for Concentrating Solar Power”; PCT App. No. PCT/US2009/041171 (filed Apr. 20, 2009) “Parabolic Trough Solar Energy Collection System”; PCT App. No. PCT/US2008/007115 (filed Jun. 6, 2008) “Parking Solar Energy Collectors”; U.S. application Ser. No. 12/854,881 (filed Aug. 11, 2010) “Solid Core Structure Parabolic Trough Solar Energy Collection System”, PCT/US2010/045240 (filed Aug. 11, 2010) “Solid Core Structure Parabolic Trough Solar Energy Collection System”, and the PCT application filed on same date as this application entitled “COMPONENTS AND SOLAR ENERGY COLLECTION SYSTEM”, inventors Kip Dopp, Darren Kimura, and Thomas Hindmarsh.

The present invention relates to the structural improvement of a concentrating solar energy collector such as a parabolic trough collector through the incorporation of (1) scalable arms that allow the collector to be scaled to a desired size without additional tooling or changes to other collector components, (2) interconnects that may increase the collector's strength, durability, and/or integrity, and/or (3) a sprocket drive system that may allow multiple collectors to be moved by means of a low torque motor.

### BACKGROUND AND SUMMARY OF THE INVENTION

Solar energy offers an environmentally friendly source of renewable and sustainable energy that does not rely on the use of fossil fuels. Solar energy also contributes relatively less to global warming and to the related environmental harms than do fossil fuel-based energy sources. Moreover, in most instances solar energy can be captured and used locally which would decrease the need to import fuels such as petroleum.

One technique for harnessing solar energy is the use of a concentrating solar power (CSP) system. Solar heaters that use concentrating troughs focus sunlight from mirrors and/or lenses onto a central receiver which can be a tube through which a heat transfer fluid flows. The trough collector may be situated to track the sun so the reflected solar energy is concentrated onto the tube. The energy concentrated on the tube heats the heat transfer fluid, which allows high quality heat from the fluid to be used to generate electricity, produce air conditioning, desalinate sea water or make steam. Trough solar energy collectors have been designed and manufactured to numerous specifications. The Micro Concentrated Solar Power (MicroCSP) collectors, for instance, may provide a modular and scalable approach to solar technology suitable for electricity generation, process heat or other energy uses.

Various MicroCSP collectors have been described in the prior patent applications referenced above. Provided herein is a scalable arm apparatus that may be used to construct scalable solar energy collection systems using fittings that accept couplers of various lengths to change the size of the reflector surface while maintaining a constant reflector focal point, or rim angle. The scalable arm apparatus may also be used to strengthen the solar energy collection systems by the use of couplers of various mechanical and material strength. The scalable arm apparatus further allows more solar energy to reach the collector as the couplers have a small physical profile and do not significantly shade the collector.

Also provided herein are various methods of assembling solar energy collectors with scalable arm apparatus, which may include mechanical fasteners and interlocking components.

Provided herein is an interconnect apparatus that may be used to construct solar energy collection systems using extruded material such as aluminum, plastic or other suitable rigid materials to provide a rigid collector assembly, so that torque can be transferred from one end of the collector to the other allowing ganged collectors to be moved by a single motor. The interconnect apparatus will also protect the solar energy collector from dirt and precipitation when the collector is in the stowed position.

Also provided herein are various methods of assembling solar energy collectors with interconnect apparatus, which may include mechanical fasteners, interlocking components and/or adhesive bonding.

Provided herein is a sprocket drive apparatus that may be used to move a solar energy collection systems (e.g., to track the sun) using a sprocket end arm assembly such that a low torque motor can move a single collector or a plurality of ganged collectors. The sprocket drive apparatus may also be used to stow the solar energy collection systems when not in use or during inclement weather. The sprocket drive apparatus further allows more solar energy to reach the collector as the sprocket drive has a small physical profile and does not significantly shade the collector.

These components of solar energy collection systems are not limited to incorporation in a particular type of solar energy collection system. These components may be used in parabolic trough solar energy collection systems, some examples of which are provided in this document. These components may be used in a linear Fresnel solar energy collection system or in a photovoltaic tracking system, such as a flat-panel collection system or a concentrating photovoltaic system.

Also provided herein are various methods of assembling solar energy collectors with sprocket drive apparatus, which may include mechanical fasteners and interlocking components.

These and other aspects of the inventions are discussed further below in the text as well as the claims, which are hereby incorporated by reference into the text herein.

### BRIEF DESCRIPTION OF THE FIGURES

FIGS. 1 and 2 depict a support structure comprised of a foam material, end arms, and end caps.

FIG. 3 illustrates hot wire cutting with a CNC machine.

FIG. 4 depicts an outer coating.

FIG. 5 illustrates two panels forming the wings, which may fit together using an H-clip that also attaches a stanchion.

FIG. 6 illustrates reflective panels on a foam material.

FIG. 7 illustrates a foam material with end caps, cowlings and inserts for a support structure.

FIG. 8 shows decorative end caps for a support structure.

FIG. 9 depicts an end arm assembly.

FIG. 10 shows a corner end panel interconnect.

FIG. 11 illustrates inserts in an end cap.

FIG. 12 shows an H-clip.

FIG. 13 illustrates a receiver tube.

FIG. 14 illustrates a stanchion that is used to hold a receiver tube.

FIGS. 15-18 depict a U-bolt assembly with a receiver tube bearing, a receiver tube bearing attachment, a receiver tube bearing attachment screw, and a stanchion bracket.

FIG. 19 shows a silicone foam gasket.

FIG. 20 depicts a glass envelope.

FIG. 21 shows inner and outer reflective covers with an insulating material.

FIG. 22 shows a locator tube.

FIG. 23 depicts a locator tube collar.

FIG. 24 illustrates a stand for a support structure.

FIG. 25 depicts torsion cables to adjust tension on a support structure.

FIG. 26 illustrates multiple cores, one bare (2603), one 2601 with reflector panel 2602, and one 2601 with a backing panel 2604 applied.

FIG. 27 likewise shows two cores, one with a backing panel.

FIG. 28-30 provide various views of partially-assembled collectors ganged together (FIGS. 28 and 29) and alone.

FIG. 31-32 illustrate inserts into cores that can be used in conjunction with screws or bolts to secure cowling, end caps, clips, backing, or other components to reflector cores.

FIG. 33 illustrates two end arms, each attached to a locator tube collar in a bearing assembly in a stand.

FIG. 34 illustrates some details of a panel joining fitting.

FIG. 35 illustrates two arc-shaped reflective panels joined to one another by a clip 3504 as well as a stanchion 3501 supporting the collector tube.

FIG. 36 illustrates telescoping glass tubes (with one tube withdrawn) concentric with the collector tube.

FIGS. 37A and 37B depict cross sectional views of two clips.

FIG. 38-40 are various views of end arms and components to form end arms.

FIG. 41-45 illustrate various components of a drive system.

FIG. 46-47 illustrate interconnects.

### DETAILED DESCRIPTION OF EXAMPLE EMBODIMENTS

Various aspects of the inventions disclosed herein may be understood better by reference to the following discussion in conjunction with the figures, which form a part of this specification and are incorporated by reference. The discussion of particular examples does not limit the scope of the invention, and the discussion is provided only to aid in understanding various aspects of the inventions disclosed herein. The claims are to be afforded a broad interpretation consistent with the principles, as well as the general and specific description herein.

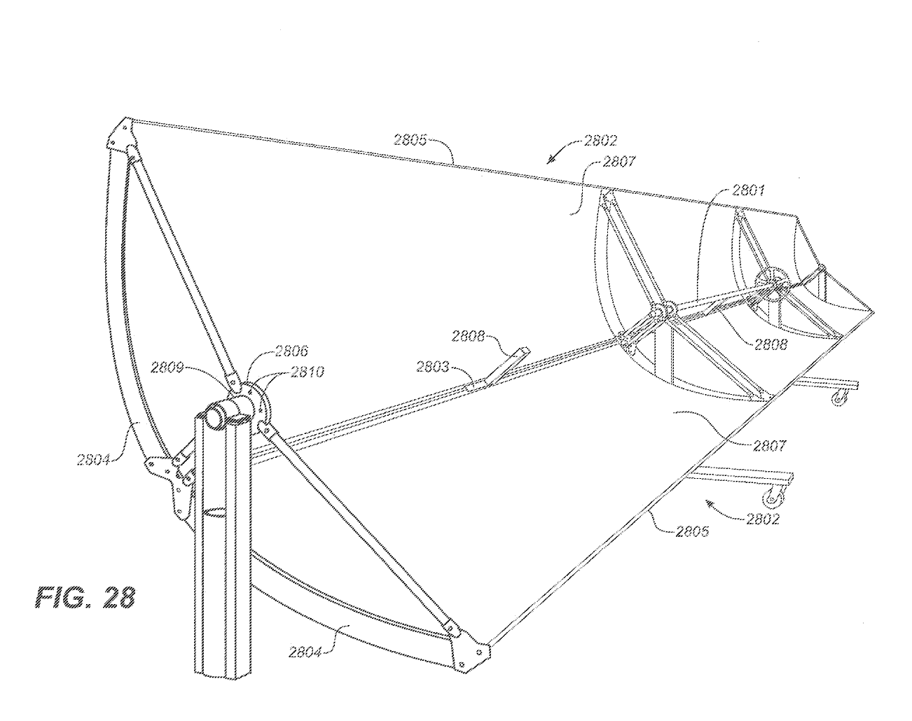

By way of introduction to various parts and combinations of parts, FIG. 28-30 illustrate a partially-assembled solar energy trough collector which may include a collector tube 2801, a plurality of arc-shaped reflectors 2802 connected by at least one fastener 2803 at a midpoint of the larger arc formed by joining the arc-shaped reflectors, and end arms 2806. An arc-shaped reflector may have a core, a reflective portion 2807, cowlings 2805, and optional end caps 2804 as described more fully below. A support structure is a trough collector as discussed above that does not have a reflective portion.

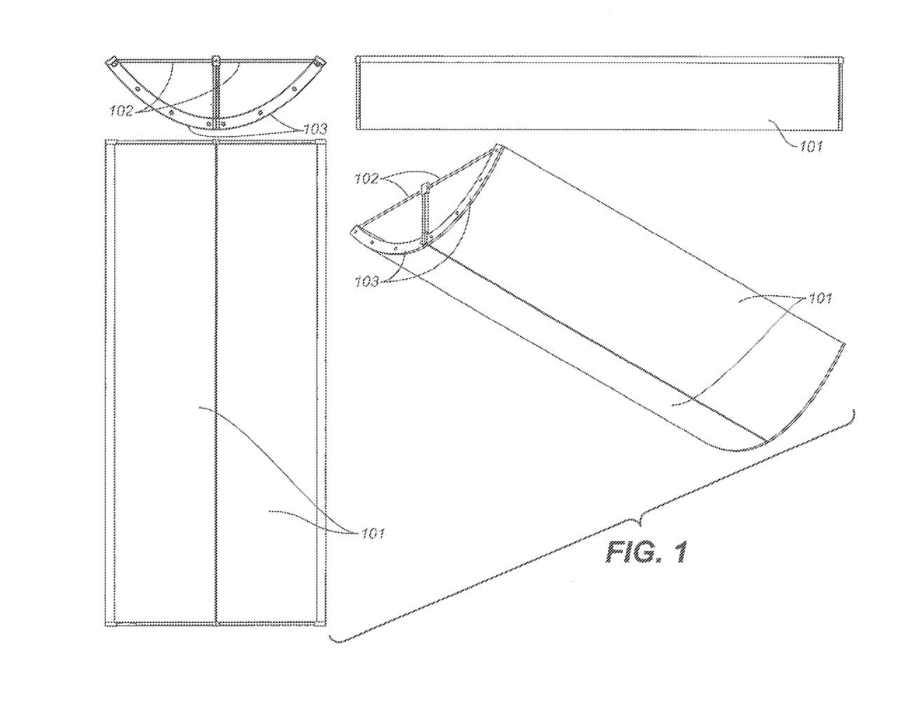

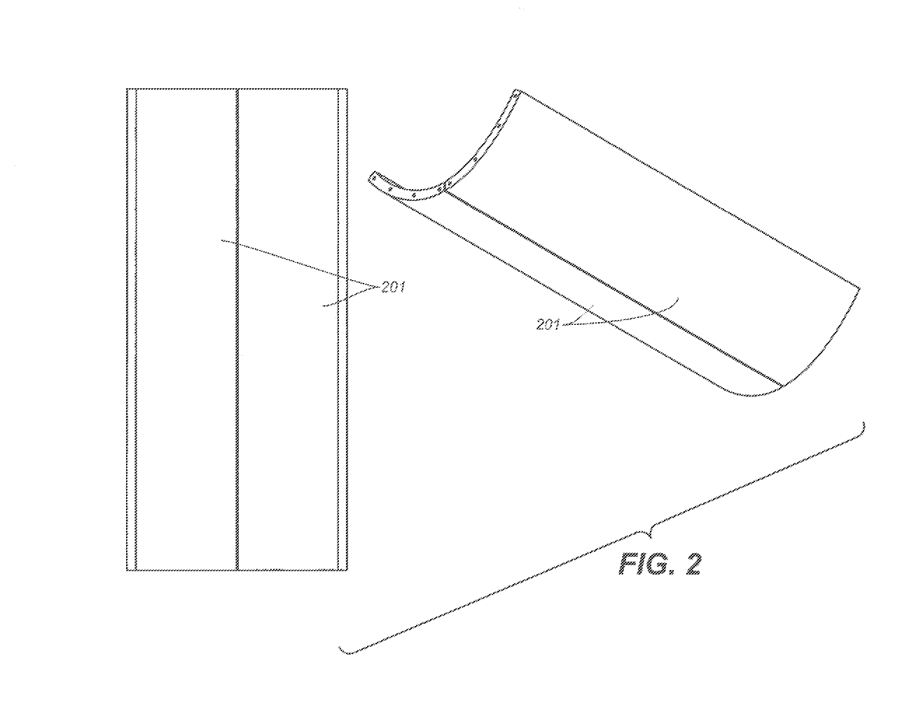

FIG. 1 illustrates how one particular collector may be formed using a core such as a foam material 201, a plurality of end arms 102, and a plurality of end caps 103. Each of these pieces is discussed below in further detail.

1. Core

A core may be a polymer, a polymeric foam material, or a honeycomb material such as a composite honeycomb sheet (e.g. aluminum honeycomb core with rigid sheets sandwiching the honeycomb and/or rigid polymer filling the interstices). A core is preferably rigid, so that a concave arcuate surface on the core may have a reflective surface applied that conforms in shape to that of the concave arcuate surface.

The concave arcuate surface may be parabolic, cylindrical, or other concave arc on one side of the core. The opposite side of the core may be of convex curvature that is a mirror image of the curvature of a second core, as explained later. The opposite side may therefore be of convex curvature or may have no curvature.

A core that is flexible may be used if it retains accurate concave curvature when other pieces such as cowling, end caps, reflective element, backing, and/or end arms are applied.

(i) Polymeric Core

A core may be a polymer such as a rigid or semi-rigid polymer. The core may be solid or a foam that has cells (either open or closed). Preferably, a closed cell foam material is used because of its moisture resistant characteristics. The polymer may have sufficient rigidity and surface strength such that the curved surface deforms little when a reflective material is applied to the surface. The core's curved surface therefore accurately imparts its curvature to an applied material.

As shown in FIGS. 1, 2, and 26, a core formed from a foam material 201, 2601 such as expanded polystyrene (EPS), extruded polystyrene (XPS), or expanded extruded polystyrene (XEPS) may be used to form the arc-shaped reflectors 101 of the collector. Other suitable materials like polyurethane, fiberglass or epoxy may alternatively be used to form the panels. XPS, for instance, has good moisture resistant characteristics. Different densities of foam may be used, and density may be around two or three pounds per cubic foot, for instance.

Foam is inexpensive to manufacture and may be locally produced, shaped, and modified. Using foam may reduce the number of parts required because tooling is not required to achieve the collector shape. The foam allows for single piece manufacturing (e.g. a core may be formed as a single piece in a mold or cut from a block of foam) and is easy to handle, thereby reducing assembly time and easing field assembly. The foam material 201, 2601 is also lightweight while maintaining sufficient strength to bear wind loads, significant advantages for roof-mount applications. The formed foam material may easily be shaped and sized to various apertures. For instance, a wider aperture increases the amount of reflective surface per panel, thereby allowing higher temperatures to be reached and therefore providing greater power conversion efficiencies.

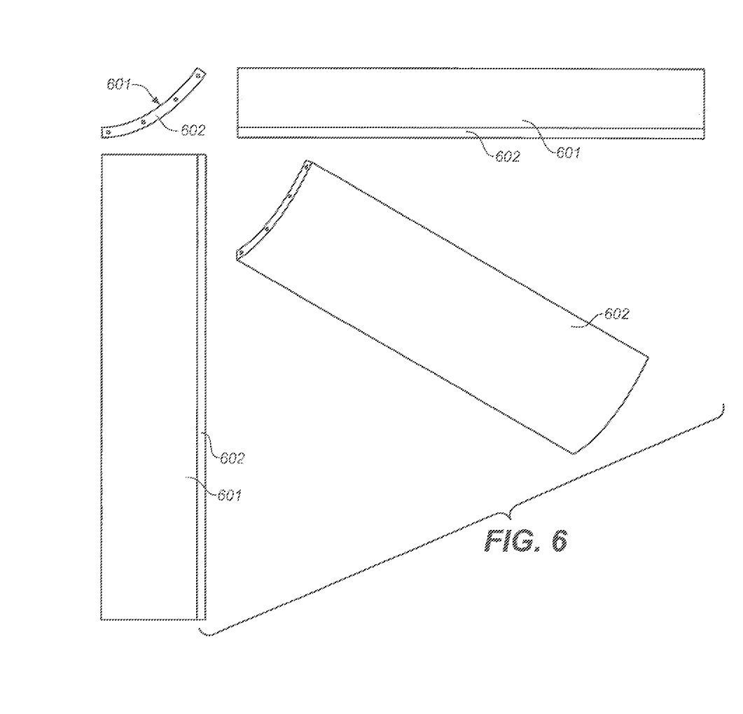

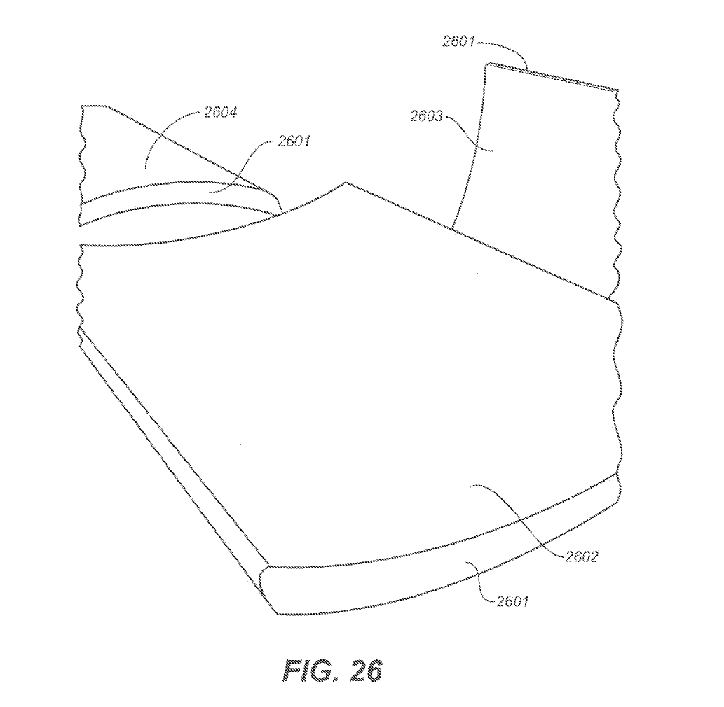

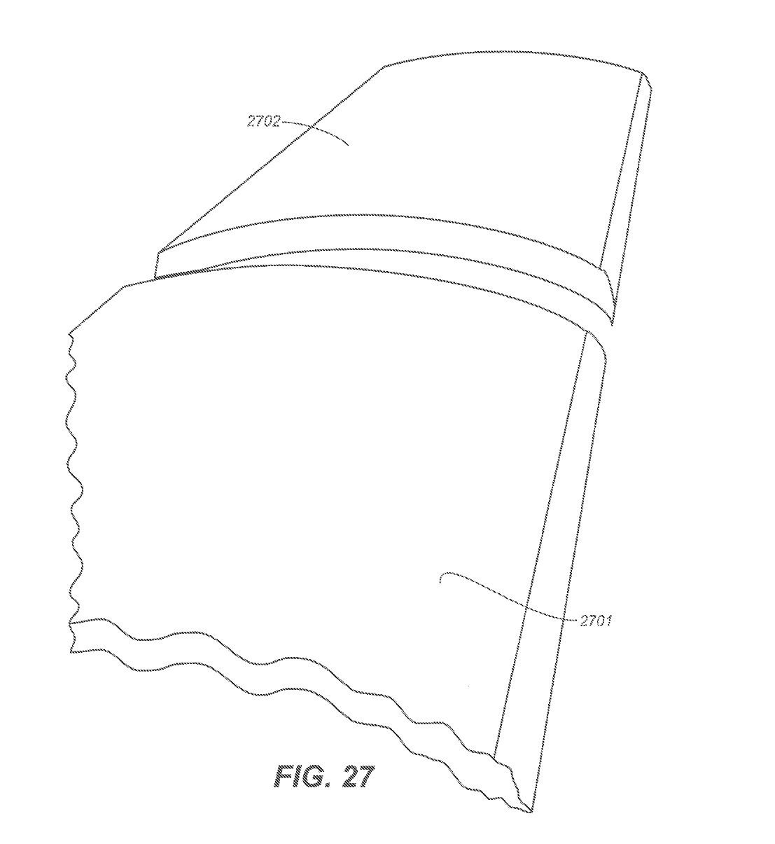

In addition, the foam core 201, 2601 may provide a better substrate for the reflective element 601 (FIG. 6) and 2602 (FIG. 26) because, when adhered to a reflective element such as polished metal, the composite is a significantly stronger and a more accurately formed structure. One reason for this is that the reflective element 601, 2602 is supported by a solid substance, the foam material 201, 2601 rather than spanning a set of ribs, as described in prior patent applications incorporated by reference above. The formed foam material 201, 2601 may provide structural integrity and resistance to forces that may flex or twist the support structure. Thus, the foam core 201, 2601 provides better support as well as a protective backing to the arcuate reflective surface.

Any core may have other materials applied to it or incorporated into it, such as moisture barrier layer or layers, adhesive, UV blocker or absorbent, and strengthening layer or layers. Thus, various protective layers of material may be applied to any or all surfaces of the core (e.g. convex and/or concave arcuate surfaces), or anchors may be incorporated into a core, for instance.

(i) Honeycomb Core

As mentioned, a honeycomb core may be e.g. an aluminum honeycomb sheet. The sheet may be made rigid by applying rigid or semi-rigid layers to one or more surfaces of the core or by solidifying a material such as a polymer in the interstices of the honeycomb. These layers may include any of the rigid or semi-rigid polymers such as polycarbonate, polyurethane, and polystyrene.

Any core will have a concave arcuate surface on which a reflective layer is placed and optionally a convex arcuate surface as well on which a backing material or materials may be placed.

2. Method to Achieve the Desired Collector Panel Shape

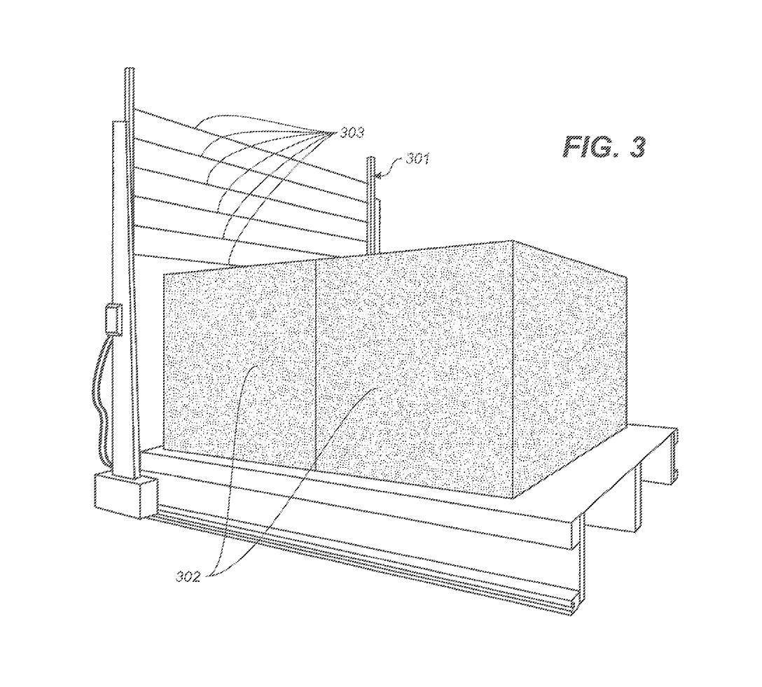

As shown in FIG. 3, the foam material 201 (FIG. 2), 2601 (FIG. 26) may be shaped into its desired panel shape by hot wire cutting one or more foam blanks 302 such as one or more blocks of foam using a CNC machine 301, or by using a laser cutting machine or other device. In the system depicted in FIG. 3, a plurality of cores are formed simultaneously by using hot wires 303 to cut one or a plurality of foam blanks. Multiple cores are therefore formed simultaneously from polymer blanks. The foam blank may be molded and cut into one or more cores 201 close to the location of any given project site thereby reducing shipping costs.

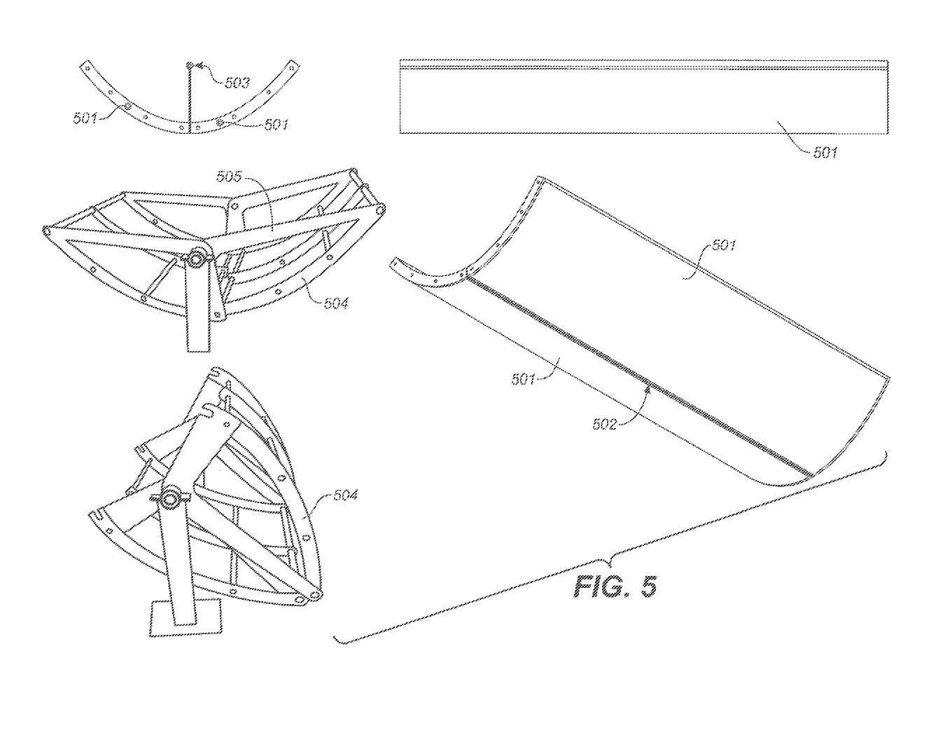

Use of a CNC hot wire 301 cutting machine to cut the foam material 201 may reduce overall tooling costs as compared to the tooling costs of stamping out ribs, described in prior patent applications incorporated by reference above. The collectors may be shaped to form parabolically shaped wings 501 (FIG. 5) whereby two pieces are positioned together along their longitudinal ends to form a complete parabolic trough collector 501 having a larger arc-length than either of the pieces. This design allows for efficient nesting of the pieces during fabrication and shipment to reduce material drop when cutting and also minimizes shipping costs. The foam sections 201, 2601 may be cut with areas of greater or lesser thicknesses to provide features like reflector stops that stand above the overall surface and help hold a reflector panel in place, height adjustment to accommodate parts that interface with the core, and areas of increased strength where needed (e.g. in the vicinity of fasteners and/or cowling).

A bottom or convex face of a core may be identical in curvature to a top or concave face of another core if desired, especially if the cores are both sliced simultaneously from the same polymer blank.

It is thought that a polymeric core may be uniform in tension and compression throughout the polymer of the core, especially where the core or multiple cores are formed by slicing a foam blank (such as a block) into the desired shape without further heating and bending of the bulk foam material. While a core may also be made by extruding the foam or by molding it, it is theorized that heating and bending foam that has already polymerized introduces compression and tension into the foam (especially into closed-cell foam), as may polymerizing a polymer in an arcuately-shaped mold.

Further, slicing a foam blank provides cores than are “skinless” as compared to a core that is formed in a mold. A core cut from a polymeric blank has little to no skin. Any skin formed by slicing a foam blank using hot wires or laser cutting is typically quite thin and/or discontinuous and is believed to be thinner overall than skin formed during polymerization in a mold. A core formed in a mold typically has a skin with physical properties much different from the bulk foam beneath the skin. When a core is sliced from a foam blank, the surface of the core is very much like the bulk foam beneath the surface. The core sliced from a blank is therefore expected to be more uniform than a core formed in a mold. Methods of slicing a core from a blank therefore provide a skinless core as distinguished from a polymeric core formed in a mold.

Further, a foam core sliced from a blank may have already been formed at a higher temperature than foam formed in a mold. Foam typically has low thermal conductivity, and it is anticipated that a large blank of foam during polymerization experiences a higher temperature within much of the foam because of the large size of the blank and/or a high temperature for a much greater period of time than does a core formed in a mold. The much smaller quantity of foam in a mold for a core can cool more quickly, providing a lower temperature at which polymerization occurs in most or all of the foam and/or a much faster cool-down time. It is therefore believed that a foam core sliced from a blank will have already been subjected to a higher temperature and/or a higher temperature for a longer period of time than a molded core experiences, a sort of “pretreatment” of the foam that may lead to longer service life for a core formed from a polymer blank.

3. Outer Coating

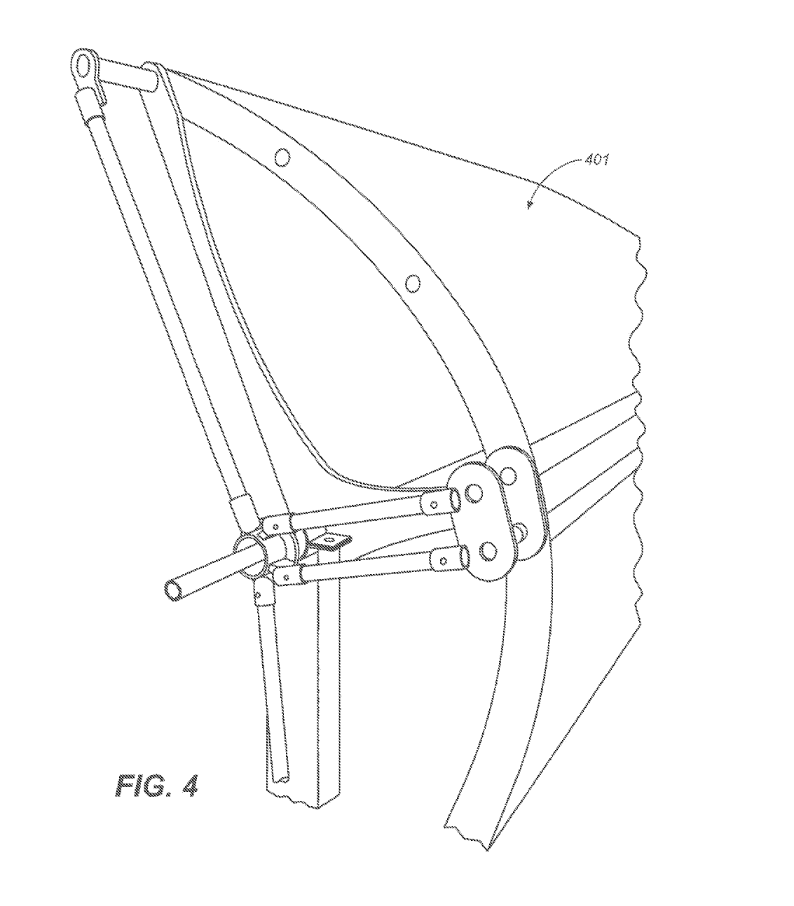

As shown in FIG. 4 and FIG. 27, the outer surface 2701 of the formed foam material 201 may be coated with a suitable outer coating 401, 2702 such as an epoxy, paint, vinyl or other UV inhibitor to (1) protect the foam from UV rays, (2) seal the foam from moisture, and/or (3) provide additional structural support. The coating 401, 2702 may be a material such as plastic or other polymer such as polyvinylchloride, metal such as aluminum, fiberglass, canvas or other material that is fused, or otherwise externally affixed to the formed foam material 201, 2601, or that may be fabric layered, thereby providing impact resistance to harsh weather. The coating may be applied by spraying, troweling, dipping, fusing or pouring the desired material onto the foam or alternatively, the plastic material may be modified to allow for the appropriate protective outer coating to be included in, or combined with, the foam material itself.

4. Arc-Shaped Reflector (Wing)

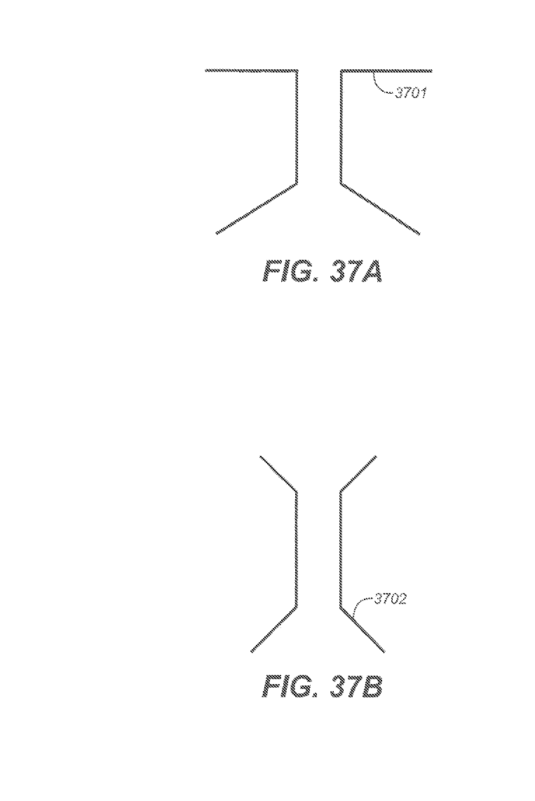

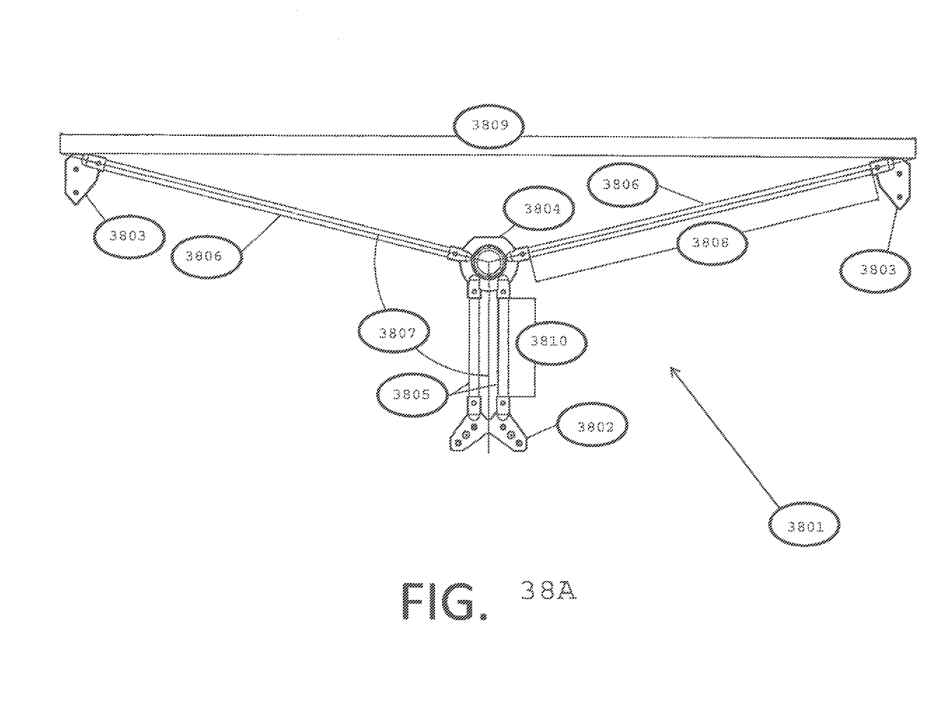

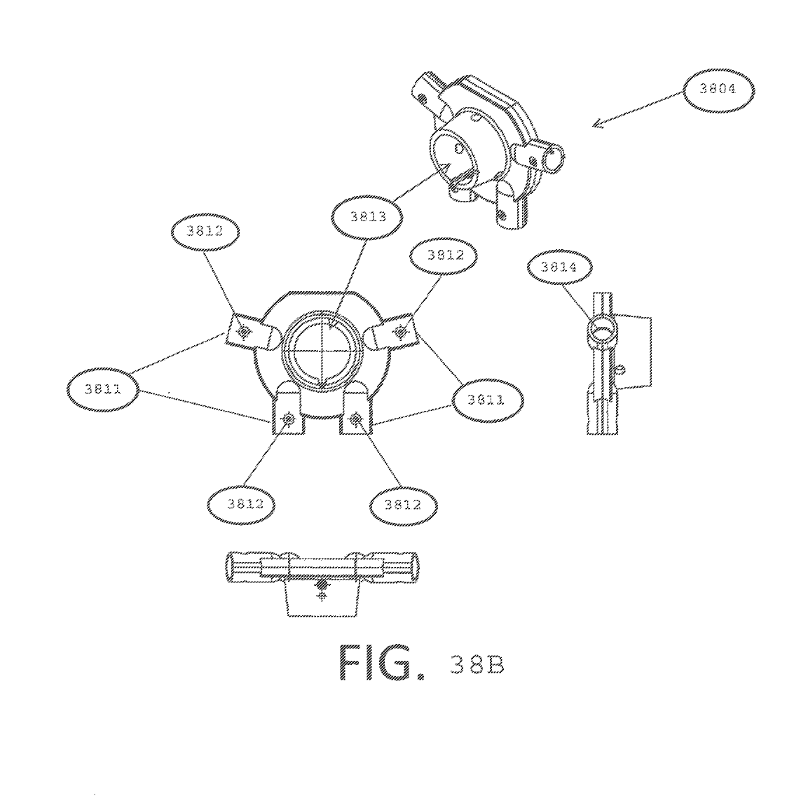

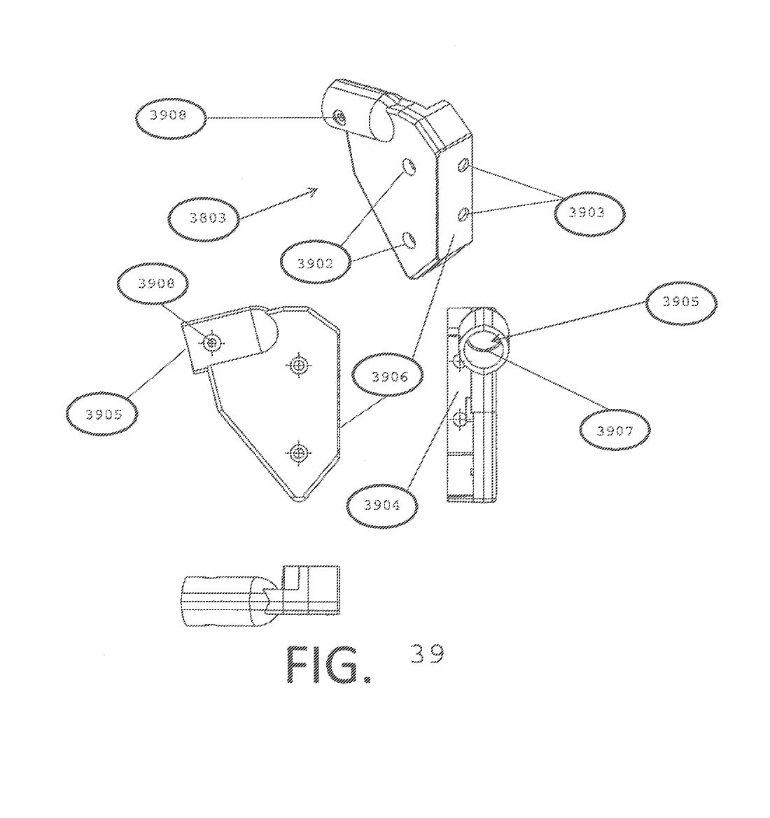

As shown in FIG. 5 and FIG. 28-30, there may be two or more symmetrical arc-shaped reflectors or wings 501, 2802. These wings 501, 2802 may be attached at the bottom of the parabolic arc with a fastener such as a clip, e.g. an H- or other shaped-clip 502, 2803 and 3701 and 3702 of FIGS. 37A and 37B described in further detail below. The clip 502, 2803, 3701, 3702 may optionally have a provision for attaching a stanchion 503, 2808 described in further detail below, which supports the receiver tube 1301, 2801 also described in further detail below.

The wings 501, 2802 may also be independently rotated so they may close in upon each other in a clamshell like configuration 504 which allows for the protection or storage of the collector. Specifically, the wings may be attached pivotably to allow each wing to pivot and rotate on top of the other 504. This protects the inside of the panel and reduces the wind load profile. The wing is driven by a sprocket assembly that when reaching a certain point, engages the second half of the panel and drives it synchronously. The wings, also or instead may be decorative.

5. Reflective Panels

As shown in FIG. 6 and FIG. 26, the core supports reflective element panels or panel segments 601, 2602 that are placed onto the formed foam surface 602, 2603. One or more reflective panels 601, 2602 may form the reflective surface upon the support structure. The reflective element may be a flexible material such as polished aluminum, aluminum laminated with reflective Mylar, or other suitable material such as epoxy sputtered with silver or a glass mirror. Preferably, a flexible aluminum panel polished to a mirror finish is used as the reflective element. The reflective element may be flexible so that a flat sheet of the reflective element can be bent into the desired shape at room temperature and pressure, or the reflective element may be rigid at room temperature and pressure but capable of being deformed into the desired shape using heat and optionally pressure or vacuum.

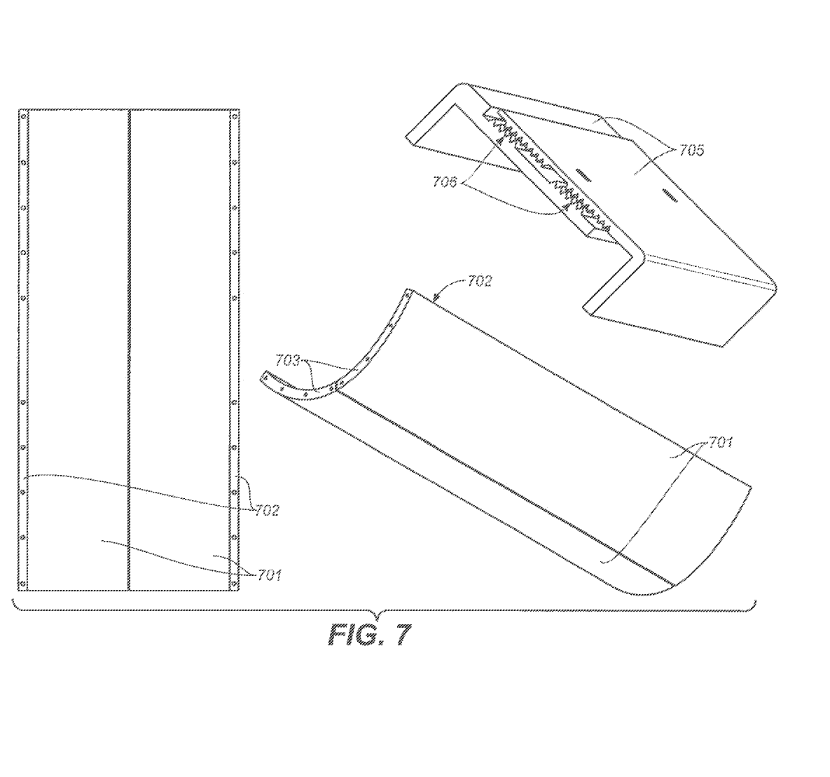

One or more flat but flexible reflective panels 601, 2602 may be retained onto the formed foam surface 602, 2603 mechanically through the use of cowlings 702 (FIG. 7) and 2805 (FIG. 28-30) and end caps 703, 2804 discussed in further detail below, or through the use of adhesion using an adhesive such as 3M adhesive, or both. The formed foam material 602, 2601 beneath the reflective element provides the desired panel shape (such as parabolic shape, flat, or partially parabolic shape that a wing may take).

6. Top and Bottom Longitudinal Cowlings

As shown in FIGS. 7 and 28-30, the formed foam material 701 and the reflective element 2807 may be mechanically held together using reinforcing cowlings 702, 2805 on each longitudinal edge of the parabola pieces. The cowlings 702, 2805 mechanically hold the reflective element in place and provide rigidity. The end caps 703, 2804 discussed in further detail below, may also serve to mechanically hold down the reflective element to the core 701.

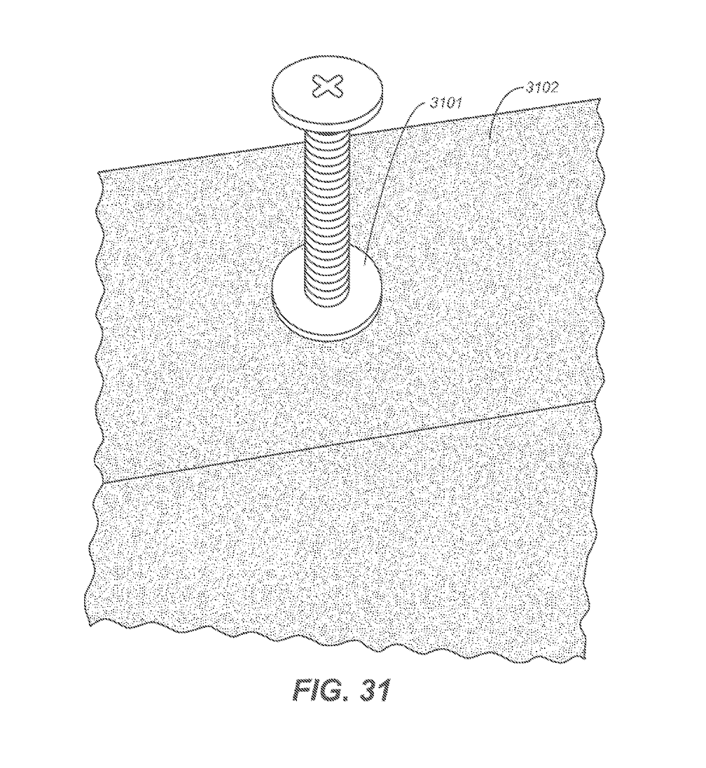

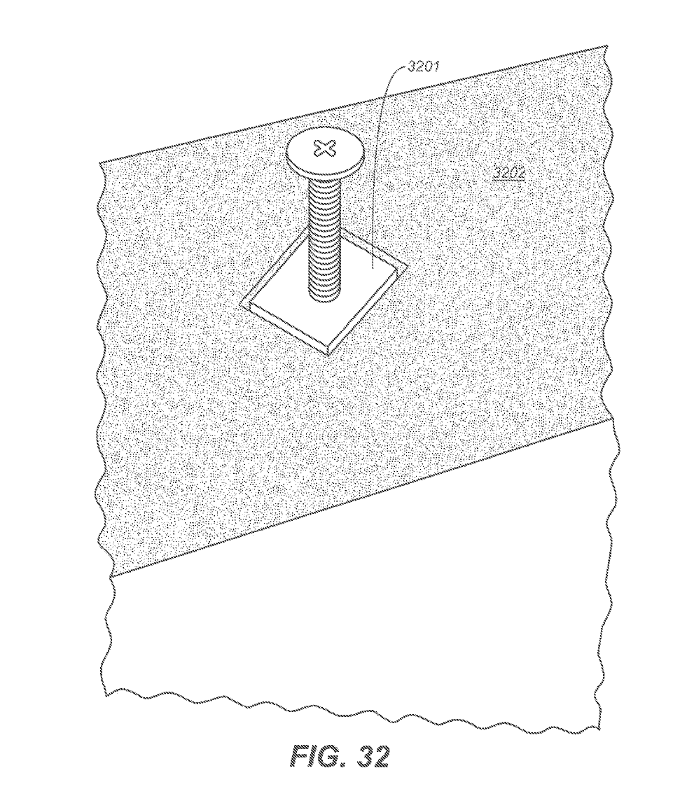

The top and bottom cowlings 702, 2805 may be made of aluminum (polished or unpolished) or other metal such as stainless steel that has high rigidity or a plastic. The cowlings 702, 2805 may be applied by positioning inserts 704 or 3101 or 3201 of FIGS. 31 and 32, discussed in further detail below, to allow fasteners to be placed into the core foam material 701, 3102, 3202. An alternative may include using glue to bond the cowlings 702, 2805 to the foam material 701, 3102, 3202 or using a band or cable to join the upper and lower cowlings 702, 2805 to prevent deflection under load.

The top and bottom cowlings 702, 2805 may also accommodate a variety of thicknesses of the combination of core, reflective element, and/or backing through the use of laterally opposed interlocking notches 706 to provide a cowling with variable opening size. This assembly 705 allows for the adjustability of the opening of the cowling assembly to accommodate varying thicknesses of the combination of the formed foam material, outer coating, and the reflective element. The adjustability of the opening may also accommodate the need to add, change, or remove the reflective material. This cowling assembly 705 also serves to lock the adjusted width in place because the cowlings legs rotate in towards the center as the width is adjusted, thereby providing increased holding pressure on the combination of the formed foam material, outer coating, and the reflective element. This may provide a significantly stronger and more secure attachment of the reflective material. Lastly, the top and bottom cowlings 702 are secured longitudinally with inserts 704 through the center to engage the edge of the panels and force the reflective material to form and maintain a parabolic shape.

The cowlings may be made of flat sheet stock that is bent into a shape to conform with the longitudinal edges of the core, or the cowlings may be rigid channels or conformal material that, alone or together with the core material, provide rigidity to the arc-shaped reflector formed from the core, reflector material, longitudinal cowlings, and optional end caps. The cowlings may themselves be polymeric (e.g. polycarbonate, solid rigid polystyrene), metallic (e.g. aluminum, stainless steel, or other material), ceramic, or other material that aids in protecting the core as well as providing additional rigidity.

7. Transverse End Caps

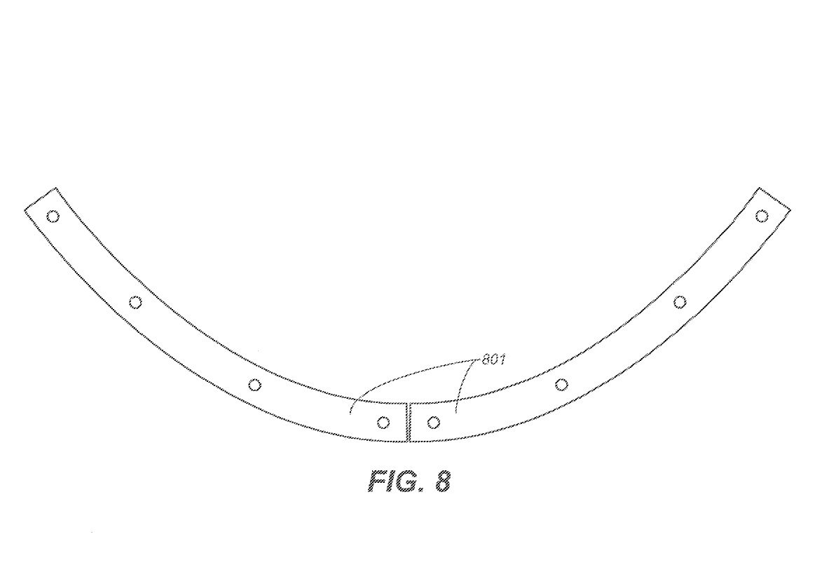

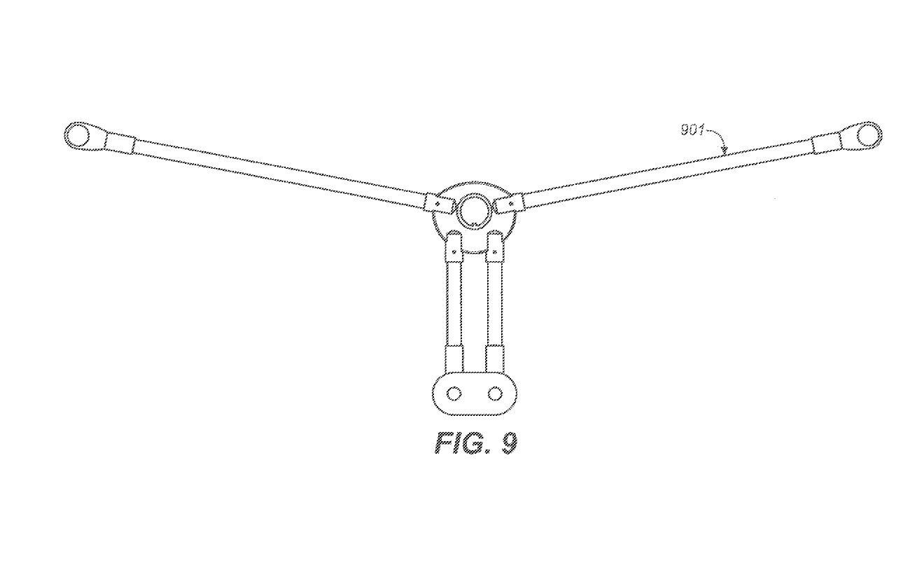

As shown in FIG. 8 and FIG. 28-30, a support structure may also have transverse end caps 801, 2804 which provide further rigidity to the assembly and resistance to flexure and/or torsion. The end caps 801, 2804 located at either end of the collector are identical and may be attached to an end arm 901 (FIG. 9), 2806 (FIG. 28-30) described below. The end caps 801, 2804 may be made of any suitable rigid material, preferably aluminum (polished or unpolished) or another metal, such as stainless steel, that has high rigidity. The end caps 801, 2804 may be used at both ends of the panels to further lock the reflective element in place, transfer load, retain the parabolic shape and provide additional structural strength to the panel design.

The end caps 801, 2804 may be a single piece of metal stamped, or otherwise cut, from a sheet and having a surface that has a shape which is generally parabolic or substantially arc-shaped to fit the profile of the formed foam material and provide a structural frame. The end caps 801, 2804 preferably may have a tab such as an outer perimeter tab to encase the edge of the formed foam material and to allow for points of attachment. The tab may therefore be configured to overlap the reflector and/or cowling, and the tab may be configured to allow the core to insert within the tabbed portion of the end cap so that the assembled pieces may be secured. The tab may protect the edge of the panel, hold the reflective element in place, add a dimension to the end cap 801, 2804 for rigidity, and provide a finished look to the support structure.

One or more ribs may be used in place of or in addition to end caps. Ribs attach directly to the end arms and form arc-shaped members that make the end-arm a more rigid structure independently of whether reflector panels or wings are attached to the core and end-arms. A rib is therefore separate from a reflector panel or wing and end cap as discussed above.

8. End Arms

End arms help to support mirrored panels and transmit movement induced by a motor to the panels to track the sun's apparent movement. An end arm may be configured in a number of ways.

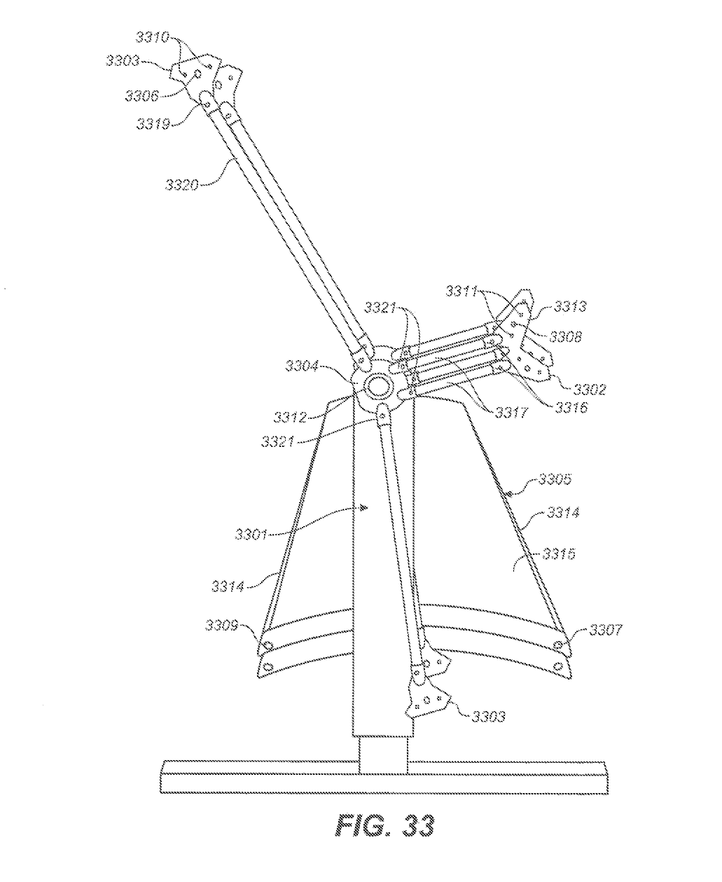

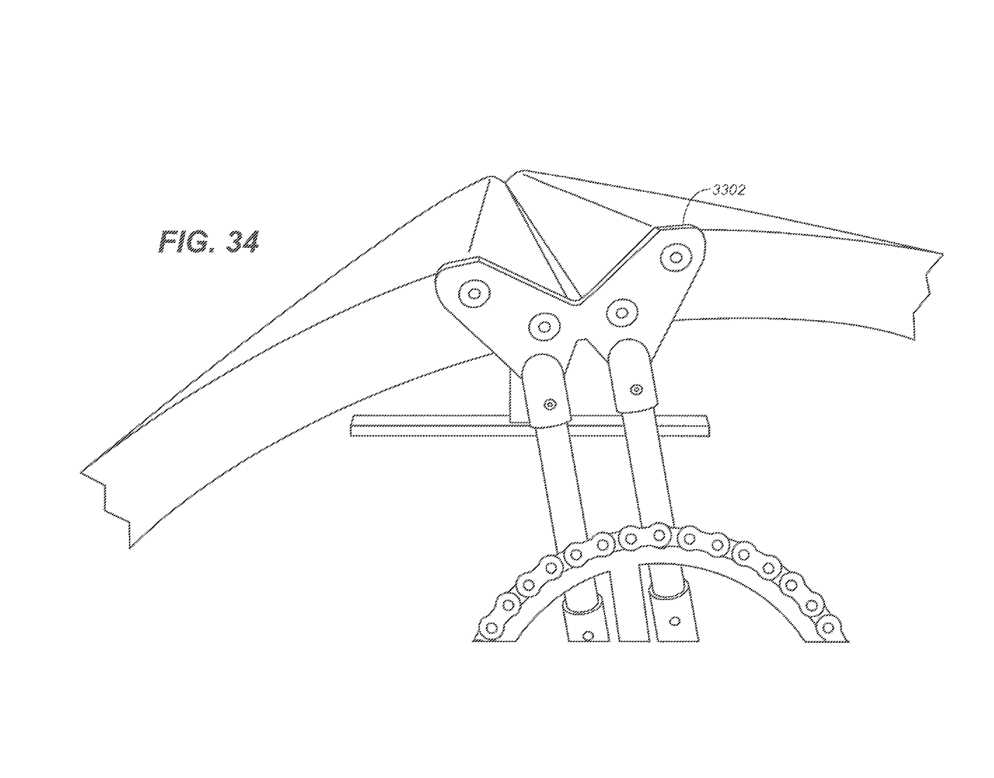

As shown in e.g. FIG. 9 and FIG. 33, the end arms 901, 3301 may be similar in function to the end arms described in prior patent applications incorporated by reference herein. The end arms 901, 3301 provide further rigidity to the support structure and resistance to flexure and/or torsion. The end arms 901, 3301 located at either end of the collector, are identical and may be attached to a stand. Additionally, the end arm 901, 3301 may rotate as one unit about the longitudinal axis.

An end arm 505 as illustrated, in FIG. 5 may be formed by stamping or otherwise cutting the end arm from sheet-metal. An end arm can be a single piece of material such as metal stamped from sheet-stock, so that the end arm depicted in FIG. 5 has a generally “T”- or “Y”-shaped structure. Alternatively, an end arm may be formed using two pieces as shown in FIG. 5 that each have a generally “L”-shaped structure. In this instance, the two stampings may be identical and positioned together during assembly to provide a generally “T- or “Y”-shaped structure when the support structure is viewed from the side. An end arm 505 may also be formed by superimposing two or more end pieces having a “T,” “Y,” or “L” shape and attaching them to one another directly or with or without a cowling. An end arm need not be “T”- or “Y” shaped. It may be solid or perforated to which parts are attached, for instance.

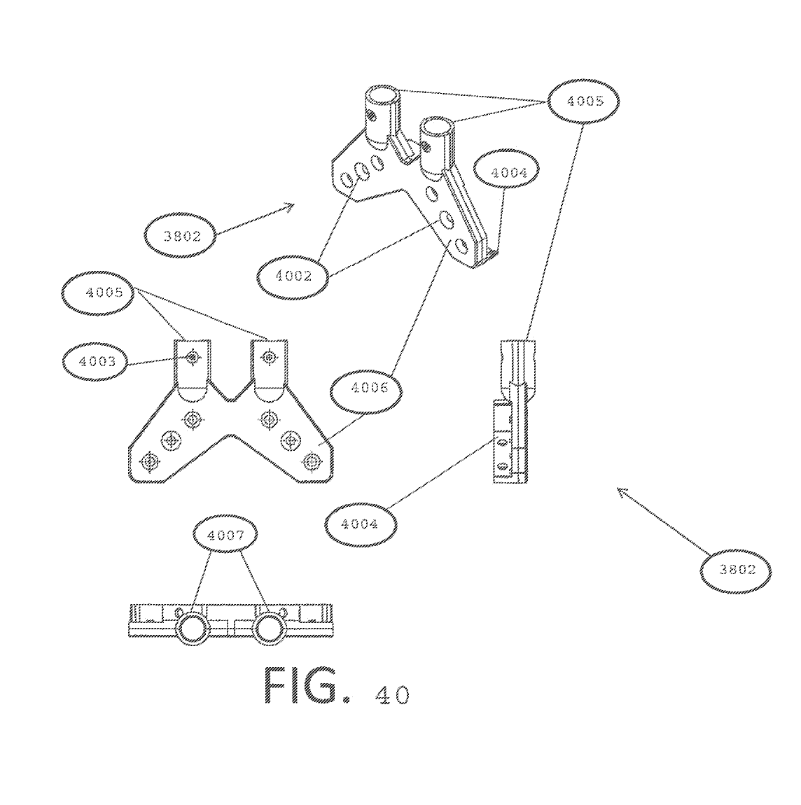

An end arm 901 and 3801 of FIG. 38A may be formed from individual fittings such as welded, die cast, or molded fittings that are formed to accept tubing, rods, or other fitting couplers and attach to the wings. As depicted in FIGS. 33, 34, and 38A-40, one embodiment of the end arms may comprise an arm bottom fitting 3302, 3802 that engages with bottom cowling of adjacent arc-shaped reflectors, an arm end fitting 3303, 3803 that engages with an arc-shaped reflector 3305 (two of which are shown stacked awaiting assembly to the end arms), and a hub fitting 3304, 3804.

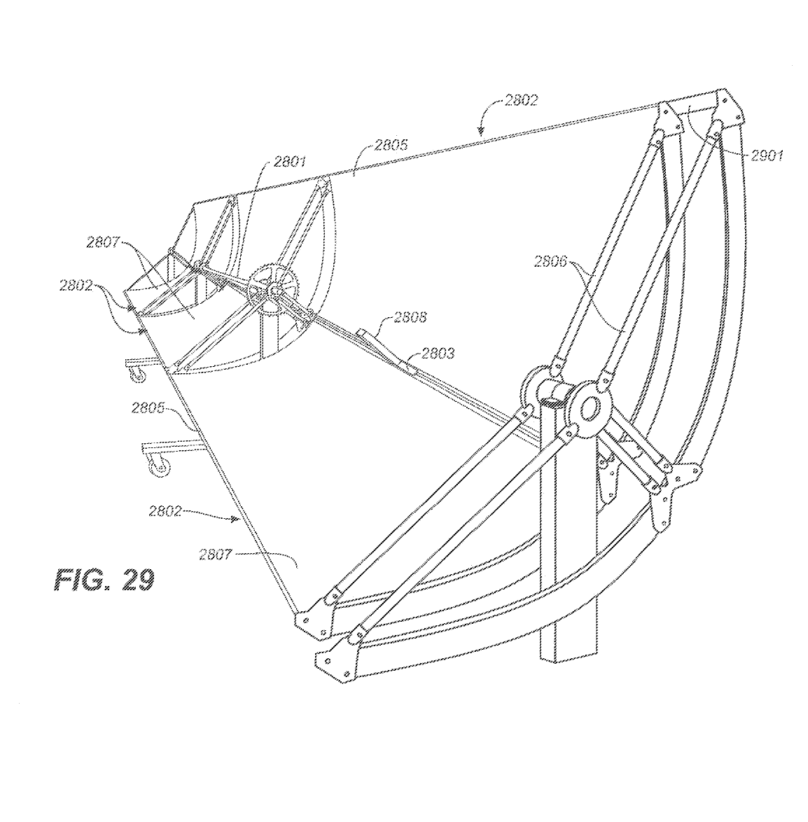

An arm bottom fitting 3302, 3802 may have a collar or shape 3308, 4004 that engages another depression or opening 3309 of the same or an adjacent panel or other structure to which the bottom fitting is to be secured. An arm bottom fitting may be formed in one piece as shown so that the piece engages both of the reflective panels of adjacent panels to form a larger arc from the two panels. An arm bottom fitting may instead be formed in two or more pieces that are secured to one another. An arm bottom fitting may have one or more collar portions 3313, 4006 that overlie an edge of the reflective layer or element and/or the cowling 3314 as well as the core. The collar portion 3313, 4006 may also or instead overlap a backing material 3315 applied to the core. The arm bottom fitting may also have holes 4002 that allow e.g. a bolt or screw to engage with a fastener or anchor in the core. An arm bottom fitting may also have one or a plurality of fastener holes 3316 that affix couplers 3317 in place when engaged with the hub fitting in the end arm assembly. An arm bottom fitting may also have a bearing surface 4007 that affixes the bottom fitting to coupler. The arm bottom fitting may be made of any suitable rigid material, preferably aluminum or another metal that has high rigidity. An arm end fitting 3303, 3803 may have a collar or shape 3306, 3904 that engages a recess or opening 3307 in the arcuate reflector panel 3305 or other structure to which it is to be secured. Screws or bolts may be inserted through holes 3310, 3311, 3902, 3903 in the end and arm bottom fittings to secure an arc-shaped reflector to the arm fitting. An arm end fitting may have one or more collar portions that overlie an edge of the reflective layer and/or the cowling as well as the core. The collar portion may also or instead overlap a backing material applied to the core. An arm end fitting may also have one or a plurality of holes 3319, 3905 that receive fitting couplers 3320 that engage with the hub fitting. An arm end fitting may also optionally have a flat rectangularly-shaped surface 3322, 3906 along an edge of the end-fitting so that e.g. a flat bar 2901 (FIG. 29) can be attached upon the edge of adjacent collectors to gang the collectors together and therefore move multiple collectors simultaneously using a single motor with drive sprocket and chain. An arm end fitting may also have one or a plurality of fastener holes 3908 that affix coupler in place when it is engaged with the hub fitting in the end arm assembly. An arm end fitting may also have a bearing surface 3907 that affixes the coupler.

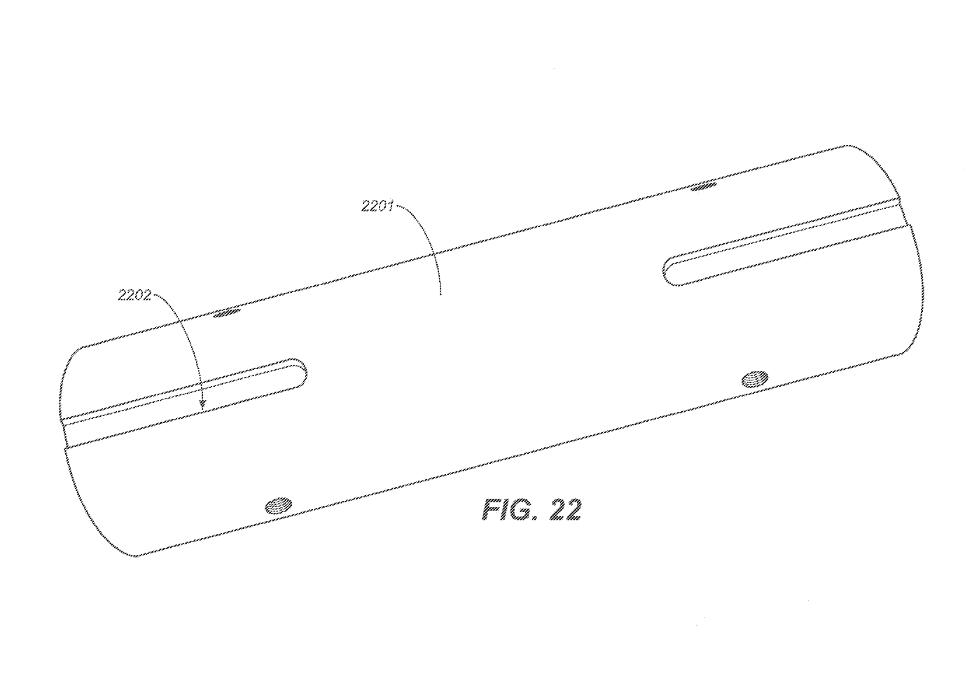

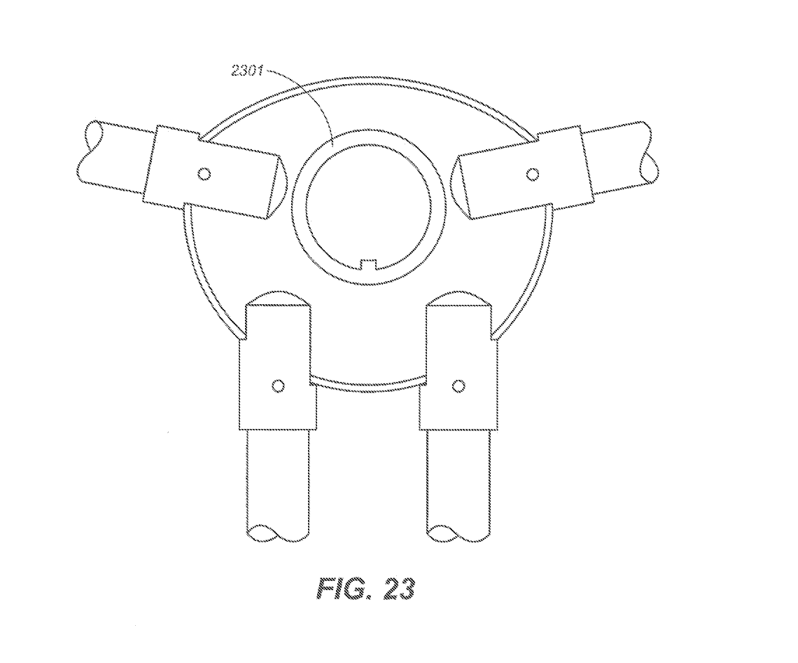

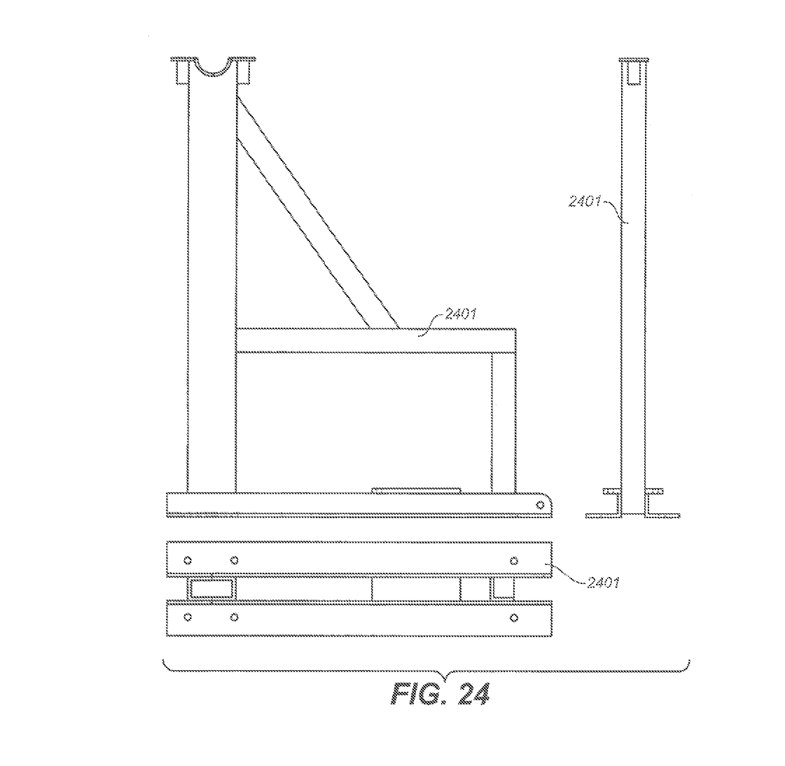

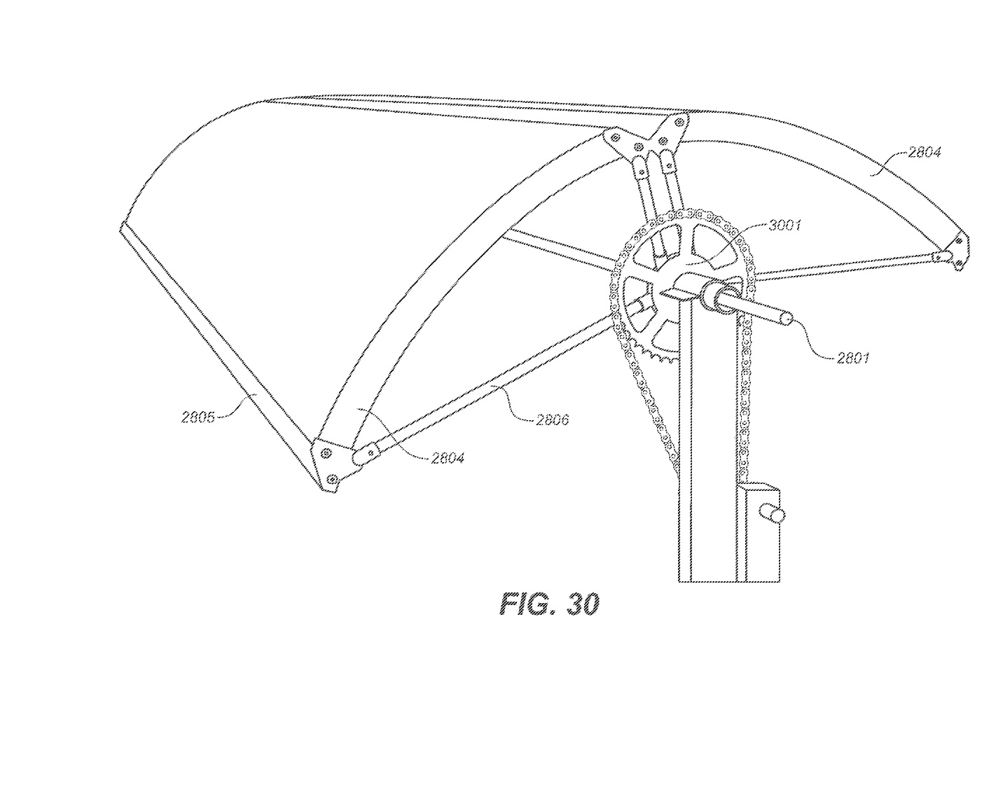

A hub fitting 3304, 3804 may have the locator tube collar mentioned previously, an end of which is depicted as 3312 in FIG. 33 and also seen as 2809 in FIG. 28. As shown in these figures and in FIG. 23, a locator tube collar 2301, 2809 of the hub fitting 3304 may be used to connect the end arms 901 perpendicular to the locator tube 2201. The hub fitting may have means for mounting a drive sprocket 3001 as seen in FIG. 30. Such means include holes 2810 (FIG. 28) such as threaded holes for bolts, a keyway and corresponding key (either as a separate piece or formed integrally with the hub fitting), screws, rivets, welding, adhesive, and any other known fastening arrangement for securing one piece to another. A hub fitting 3304, 3804 also may have holes 3321, 3811 extending radially from the hub and into which couplers 3317, 3320, 3806 insert to couple a plurality of arm end fittings and one or a plurality of arm bottom fittings. The locator tube 2201 (FIG. 22) inserts through the locator tube collar 2301, 2809 of the hub fitting and engages with a bearing. The bearings may be roller, ball, plastic, or graphite bearings that are retained in the stand by screws in the stand and from a cap that mates with the stand. A hub fitting may also have one or a plurality of fastener holes 3812 to affix coupler in place when the coupler is engaged with the arm end fitting and the arm bottom fitting in the end arm assembly. A hub fitting may also have a bearing surface as discussed previously that affixes the end arm to the remainder of the collector when the coupler is engaged with the arm end fitting and arm bottom fitting in the end arm assembly. The hub fitting, made of any suitable rigid material, preferably aluminum (polished or unpolished) or another metal such as stainless steel that has high rigidity, slides onto the locator tube 2201 and may be secured with bolts and/or a keyway 2202. The keyway may allow for accurate positioning of the locator tube collar 2301, 2809 on the locator tube 2201. The collar 2301 may consist of one or more elements that allow each end arm 901, 3301 to rotate independently of the other so the wings may rotate together in a clamshell configuration as mentioned earlier.

The couplers 3805, 3806 set up a relationship between the hub fitting 3804, the arm end fittings 3803, and the arm bottom fitting 3802 such that when the couplers are increased or decreased in length 3808, 3810 a common rim angle 3807 is maintained while increasing or decreasing the aperture width 3809, but leaving the location of the collector's focal point unchanged despite the change in aperture width 3809.

The couplers 3805, 3806 may also provide different structural strength to the support structure depending on the load requirements of the support structure (e.g. wind loads or torsional loads). The couplers achieve the different structural strength by being either solid rods or hollow tubes of different materials such as aluminum, stainless steel, plastic or other sufficiently strong materials. In addition, when the couplers are made of hollow tubes the structural strength of the coupler can also be changed by varying the wall thickness of the tube.

The common rim angle 3807 is achieved by cutting or forming couplers to the lengths 3808, 3810 that set the desire aperture width 3809 for the collector. The couplers are then affixed to the hub fitting 3804, arm end fitting 3803 and arm bottom fitting 3802 by means of either a bearing surface (e.g. 3814), fastener holes 3812, 3908, 4003 or any other fastening means sufficient to maintain the relation between the hub fitting 3804, 1201, the arm end fittings 3803 and the arm bottom fitting 3802.

Couplers 3317 and 3320 may run radially from the hub fitting 3304 on a locator tube collar and to the end 3303 and bottom 3302 fittings, thereby forming generally two “L” shapes or a “Y” shape. Various lengths of couplers may be used to adjust the shape and length of the end arm 901, 3301 to allow forming collectors of varying aperture widths mentioned earlier. The fittings may be rods such as solid or tubular metal rods (e.g. aluminum), and the rods may be e.g. cylindrical, square, rectangular, regular, or irregular in cross-section.

The fittings and/or couplers may be formed of polymer (such as a rigid non-foamed polymer as discussed herein), metal such as aluminum, ceramic, or other suitable material.

An end arm as illustrated herein may be quite strong. An end arm as illustrated having two arm end fittings, one bottom fitting, and one hub provides triangulated loading and rigidity when an end arm is secured to a structure to be rotated such as a parabolic mirror or a framework to which solar panels are mounted.

The end-arm design provided herein allows a plurality of different end arms to be formed using the same components. A wide array of different end-arms can be formed using the same hub, arm bottom fitting, and arm end fittings but using different couplers. The couplers may be formed of the same material and may be otherwise identical except their length differs. The couplers may be formed of the same material but have different wall thickness where at least one of the couplers is not solid all the way through. Couplers may be formed of different materials (e.g. one end-arm may be formed using metallic couplers, and another end arm may be formed using polymeric couplers; or, one end-arm may have couplers formed from one type of aluminum or alloy and another end-arm may have couplers formed from a different type of aluminum or alloy). Any combination of these differences may also exist (e.g. one end-arm has couplers formed of aluminum and have a first length, and another end-arm has couplers formed of aluminum alloy that have a second length different from the first length).

A shop may therefore stock one type of hub, one type of arm bottom fitting, and one type of arm end fitting but different types of connectors as discussed above to make a wide variety of end arms. Or, a shop might stock two or three different types of hubs and corresponding sets of arm bottoms and arm end fittings in order to make a much greater variety of end arms. A small number of standardized sets of hub/arm bottom fitting/arm end fitting enable a large number of different end arms to be formed. Since connectors are often tubular metal, they are inexpensive, and a large variety of different couplers can be obtained at reasonable cost.

A wide array of different solar energy collectors may be formed as a result of the different end arms which may be formed, and any of the solar energy collectors mentioned above may incorporate end-arms as discussed herein.

9. Corner End Panel—Ganging

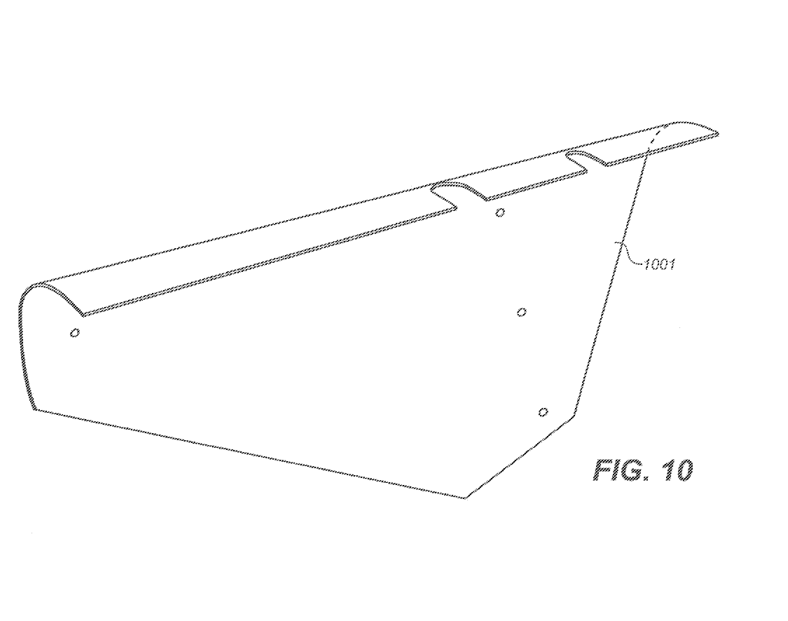

As shown in FIG. 10, there may be a corner end panel interconnect 1001 that serves to tie the end caps 1102 to the cowlings 702 structurally, providing for extra strength and support. The corner end panel interconnect 1001 may be made of any suitable rigid material, preferably aluminum (polished or unpolished) or a metal such as stainless steel that has high rigidity. It is either die cast or metal stamped into its desired shape.

The corner element 1001 may bridge one panel to another to maintain alignment and transfer torque to the next row of collectors. Potentially, multiple corner end panel interconnect 1001 pieces may be used to tie the bottom cowlings together to form an I-beam type structural member. This member may also be a one piece extruded shape.

An interconnect may also be a section of flat bar 2901 (FIG. 29), for instance. And arm end fitting may have a flat rectangularly-shaped surface 3322 along an edge of the end-fitting so that e.g. flat bar 2901 can be attached to the edge of adjacent collectors to gang the collectors together and therefore move multiple collectors simultaneously using a single motor and drive sprocket.

10. Sprocket Drive

A collector or a linear array of collectors ganged together as discussed above may have a drive system positioned, for example, at one end as illustrated in FIGS. 41 and 45. In these figures, the drive system 4101 comprises an arm sprocket 4102 secured to the end arm couplers 3806 by sprocket bracket 4103. A drive motor 4104 having a small diameter sprocket 4105 on a shaft 4106 of the drive motor 4104 and secured to a support stand 2101 or other structure, so the motor does not rotate with the collector 101, along with a chain 4107 or belt engaging the small sprocket 4105 on the motor 4104 and the arm sprocket 4102 on the collector. Optionally one or more adjustable idler sprockets 4501, 4501′ (FIG. 45 and FIG. 46) may be added along the length of the chain that tension the chain to remove slack in the sprocket drive assembly.

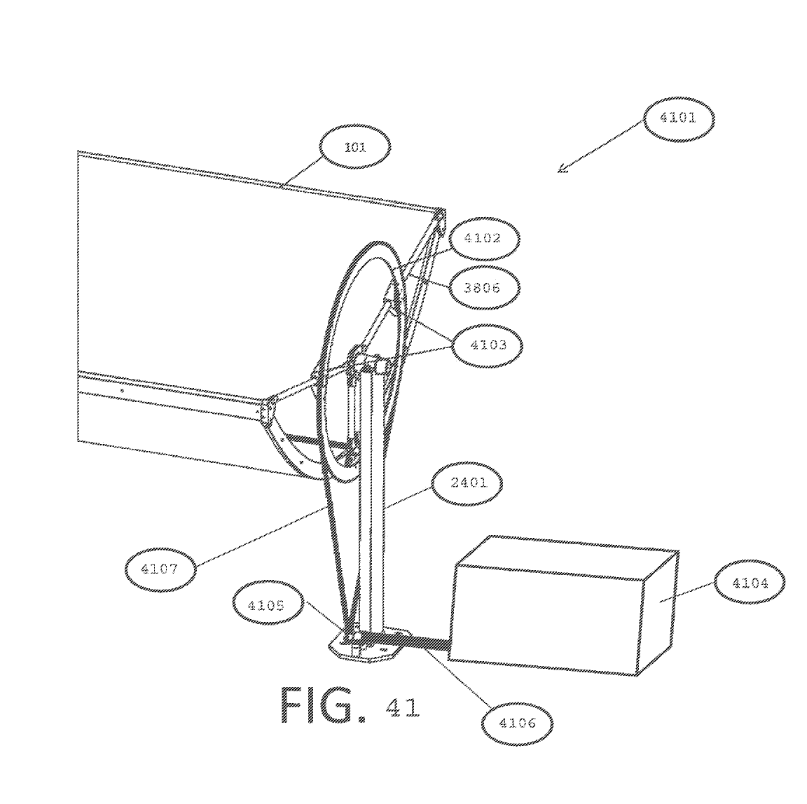

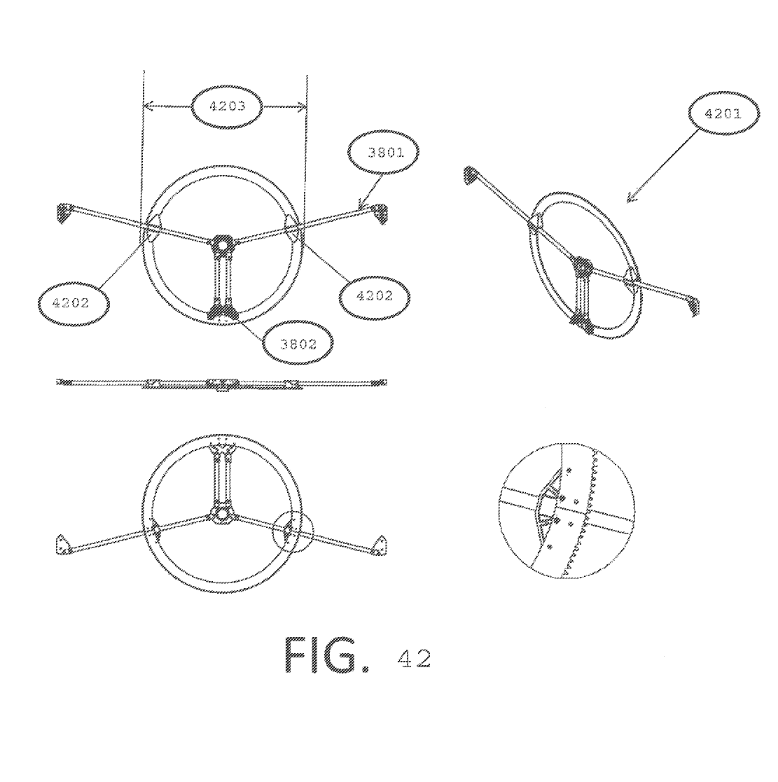

The arm sprocket 4102 or 4201 shown in FIG. 42 may be attached to the end arm assembly 3801 directly through the arm bottom fitting 3802 and to coupler fittings 3806 indirectly through sprocket brackets 4202.

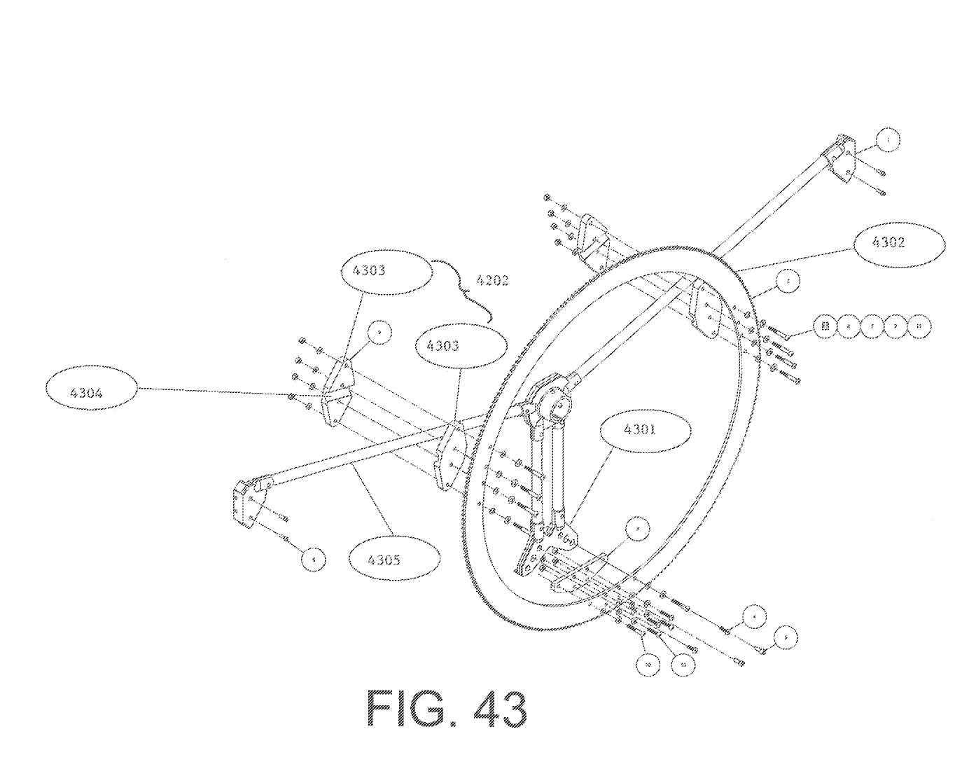

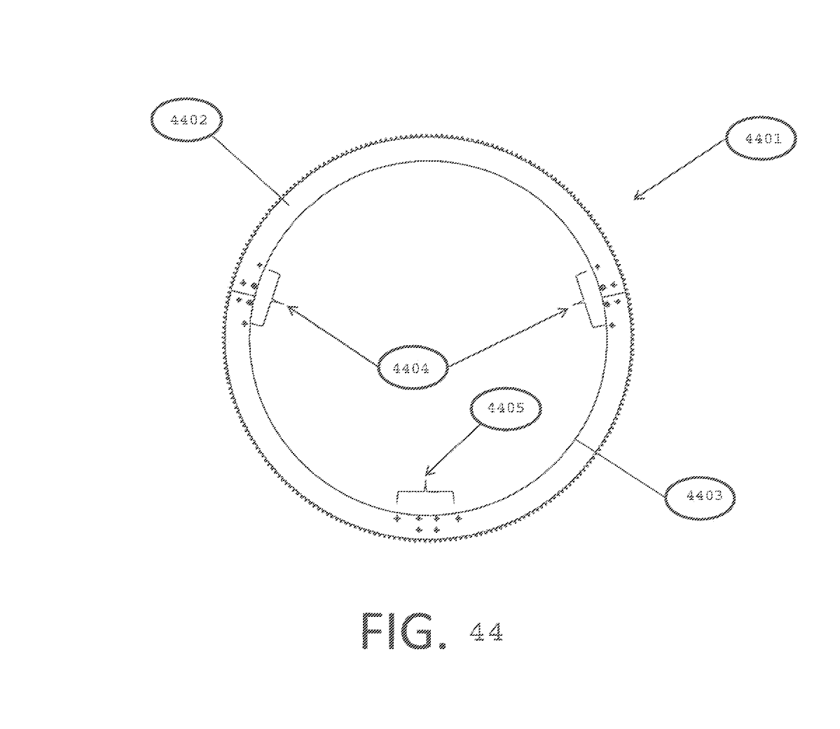

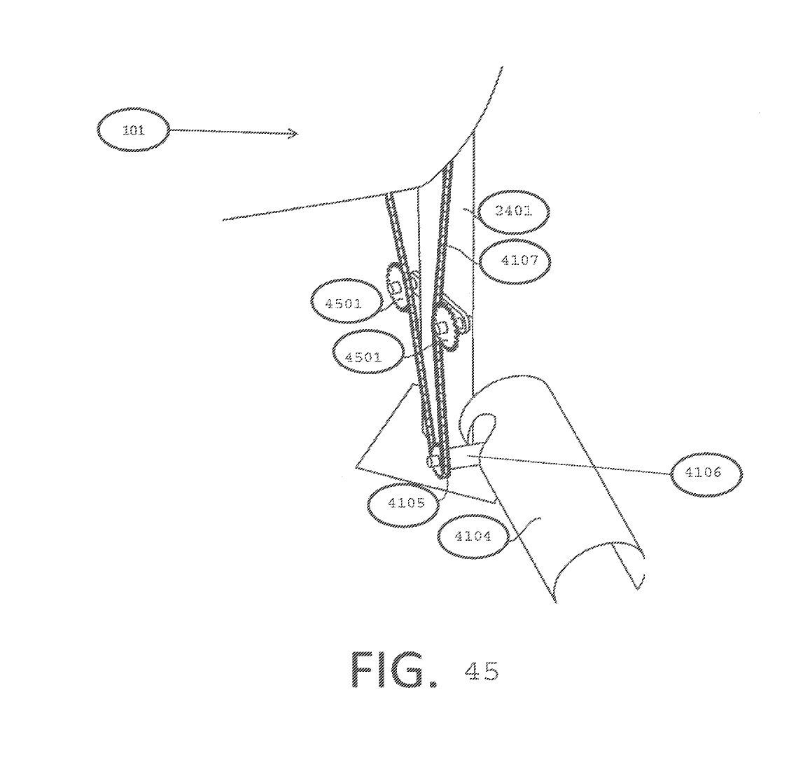

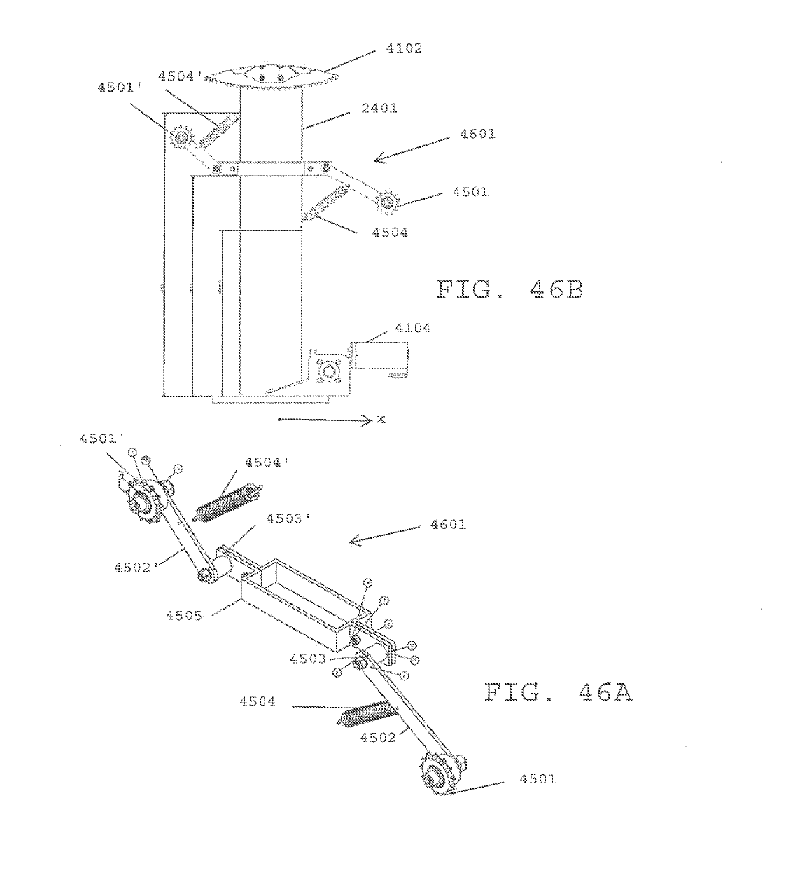

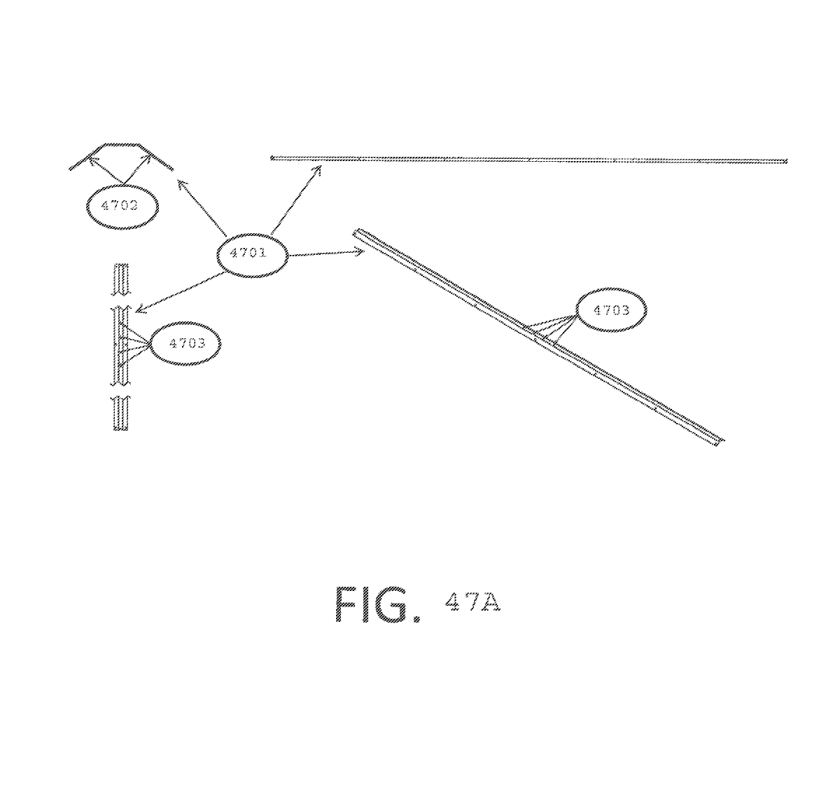

Details of sprocket brackets 4202 and are illustrated in FIG. 43, which is an exploded figure of one example of an end arm and sprocket assembly. The arm bottom fitting 4301 may be connected to the sprocket 4302 using a spacer, nuts, bolts, screws, and/or washers as depicted in the figure. Sprocket brackets 4202 in this instance are formed of two identical pieces 4303 that each have a depression or channel 4304 to allow the pieces to mate around a connector 4305 and attach to the sprocket 4302, securing the end arm/sprocket assembly so that no slippage occurs between the sprocket and end arm as the sprocket is rotated.

The arm sprocket 4201, 4102 has a sprocket diameter 4203 that may be any diameter that would be encompassed by the end arm assembly 3801. This would allow the sprocket diameter 4203 to be large relative to the small diameter sprocket 4105 resulting in a high gear ratio, so the motor 4104 torque can be reduced while still being able to move the collectors. The reduction in required motor torque also decreases the power consumption required by the motor 4105 to move the collectors.

The arm sprocket also utilizes the strength of the end arm assembly to rotate the collectors rather than having to rotate the collectors from the hub of a sprocket, which would require additional strength in the sprocket to transfer the motor torque to the collector. The additional strength in the sprocket would necessitate more material (e.g., spokes) in the sprocket thus shading the collector reducing the amount of sunlight reaching the collector.

The arm sprocket 4201, 4401 would be made of a sufficiently rigid material such as aluminum, so that the thickness of the arm sprocket 4201, 4401 could be kept at a minimum, but the sprocket would still be rigid enough to transfer the torque from the motor 4104 to the collector.

In one variation of the sprocket arm 4401, the sprocket arm 4401 would have an upper sprocket half 4402 and a lower sprocket half 4403, which would allow the sprocket halves to be nested together when cut to shape resulting in a reduced material drop that would occur by cutting out the center of a complete sprocket. In the sprocket arm 4401 shown in FIG. 44, the upper and lower sprocket halves 4402, 4403 would be trimmed, so that the halves may be affixed to each other by the sprocket brackets 4202 by screws, bolts or other known fastener methods through the holes 4403. The lower sprocket half may be additionally attached to the arm bottom fitting 3802 by screws, bolts or other known fastener methods through the holes 4404.

The large driven sprocket that attaches to the solar energy collector may have no reinforcing members within the annulus formed by the sprocket so that the area encircled by the sprocket has no material within it (such as cross-bars or other reinforcing structure formed of the same material as the sprocket is formed). As illustrated in e.g. FIG. 43, a sprocket with no reinforcing webs or bars gains substantial rigidity or resistance against a twisting, deflecting, or other deforming force by being mounted to an end arm at three regions or more (preferably spaced equidistantly).

One particular idler sprocket assembly 4601 is illustrated in FIGS. 46A and 46B. Idler sprocket assembly 4601 has two sprockets, 4501 and 4501, each of which is capable of moving in a generally horizontal direction in order to tension its chain (corresponding to chain 4107 illustrated in FIG. 45 but-not illustrated in FIG. 46 for sake of clarity). In this particular instance, the idler sprocket assembly has arms 4502, 4502′ which pivot about pivots 4503, 4503′. One of the sprockets is offset vertically from the other of the sprockets despite having pivot points at the same elevation. While not being bound by theory, this configuration may allow the sprockets to tension the chain and guide it in a way that provides accurate rotational control and less stress on the chain, with little hysteresis in rotation, especially if the drive sprocket is offset from the center of the collector's large driven socket and if the collector is configured to rotate in a direction from the lower idler sprocket (positioned closer to the drive motor in the x-direction) and toward the higher idler sprocket (positioned further from the drive motor in the x-direction). The same effect may be obtained by providing a lower mounting point for an idler sprocket closer to the drive sprocket in the x-direction and a higher mounting point for an idler sprocket further from the drive sprocket in the x-direction, even if the idler sprockets were only capable of horizontal motion. The idler sprockets may be positioned so that they are pulled toward a common mount such as stand 2401 (springs 4504, 4504′ being in tension during use), or the idler sprockets may be pushed from adjacent stands (using e.g. springs in compression). In the particular arrangement illustrated in FIG. 46, pivots 4503, 4503′ are mounted to bracket 4505 which may be mounted to stand 2401. Alternatively, the movable idler sprockets may be mounted to the stand itself without bracket 4505.

11. Inserts/Anchors

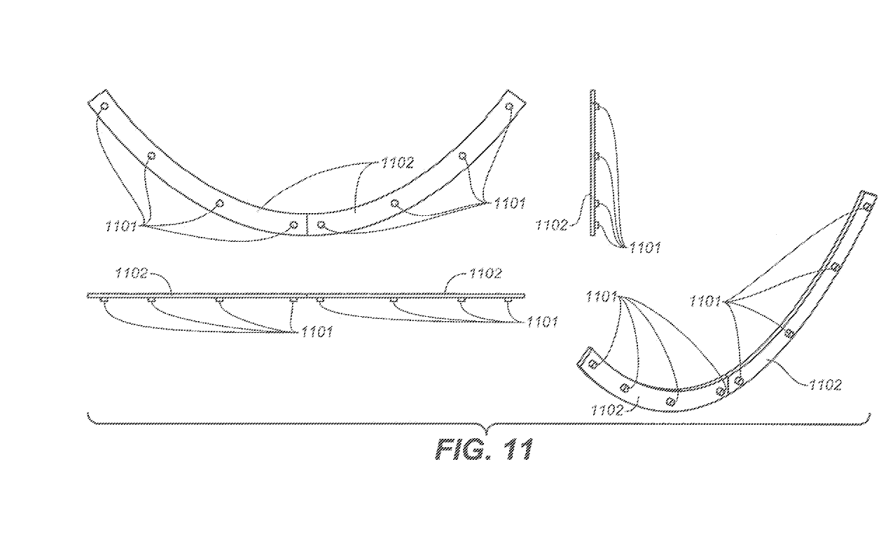

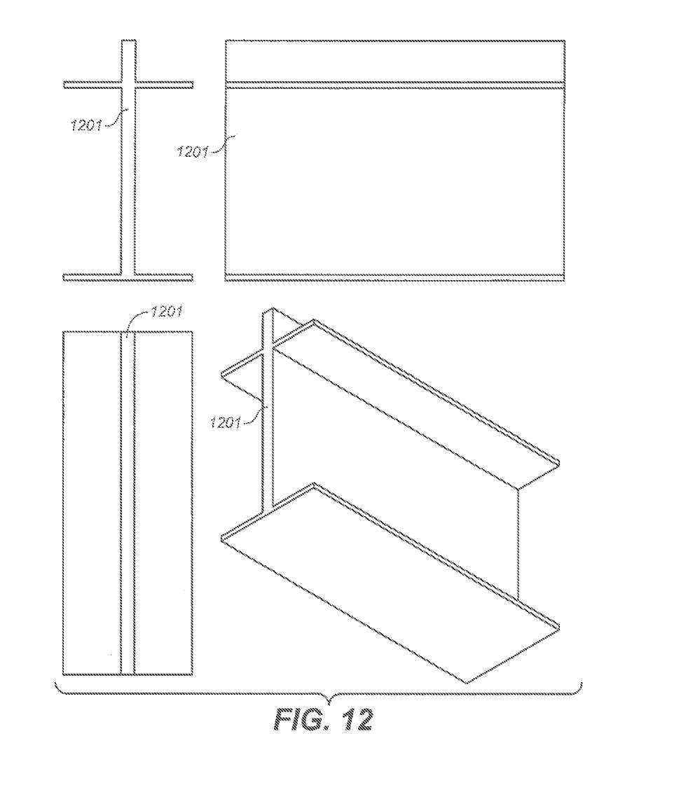

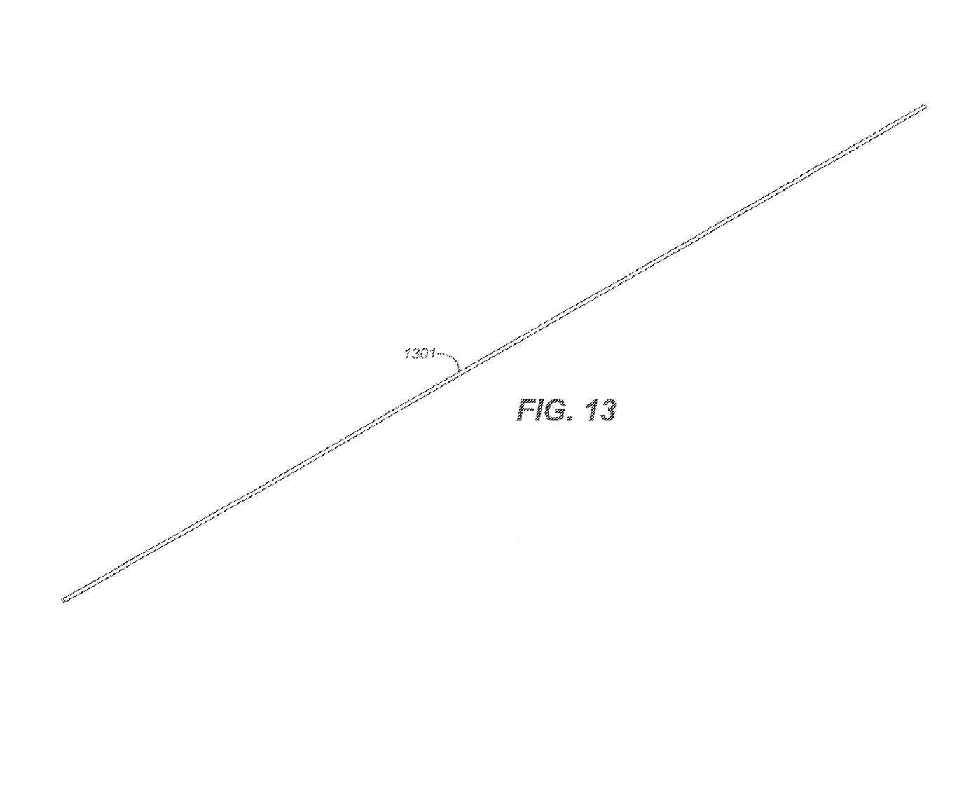

As shown in FIGS. 11, 31, and 32, inserts 1101, 3101 or embedded anchors 3201 may be used to attach the cowlings (e.g. FIG. 7 702, FIG. 28-30 2805) to the formed foam material 701, 3102, 3202. One insert or anchor 1101, 3101, 3201 may be used every few feet. The inserts or embedded anchors may also be used to secure the end caps 1102 that maintain the parabolic shape and engage with the end arms 901, 2806 as a means of support.

An insert may be glued into foam or other polymer of a core, as shown in FIG. 31. The foam may be melted, and an insert may be anchored into the foam by heating and embedding it and allowing the polymer to resolidify around the anchor. As shown in FIG. 32, a small hole may be formed in a surface of the foam by melting the surface, and the insert may be glued into the hole.

12. Fastener or Wing Interconnect (e.g. Clip or Other Interconnect)

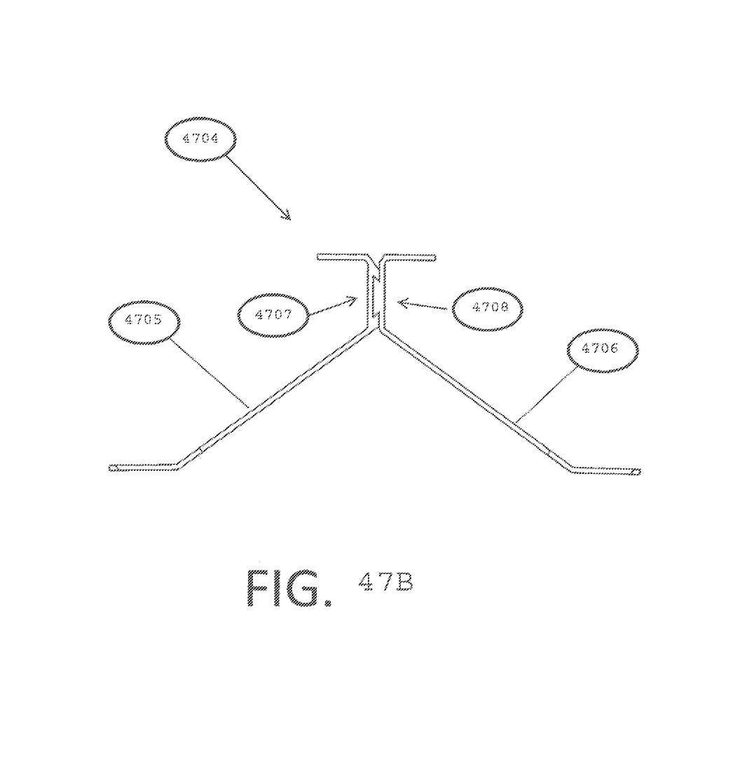

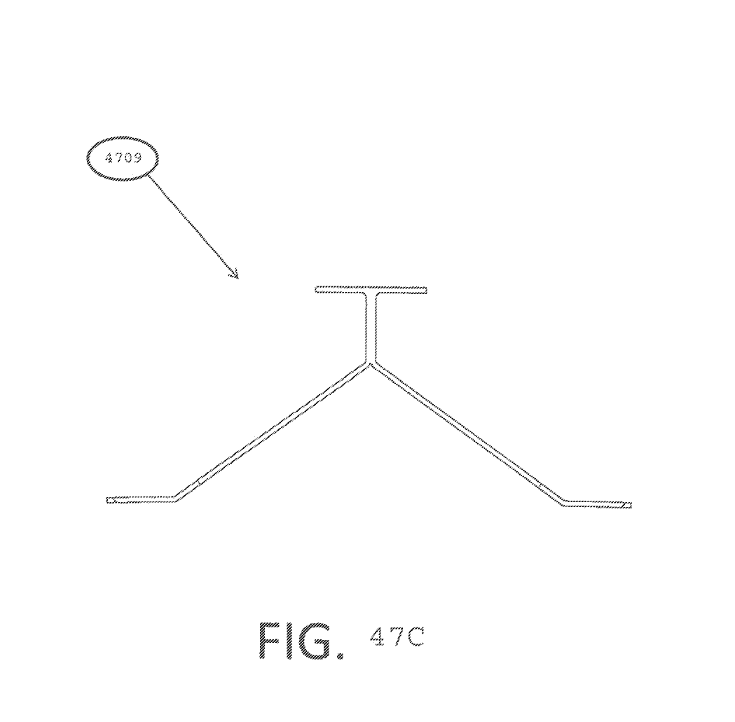

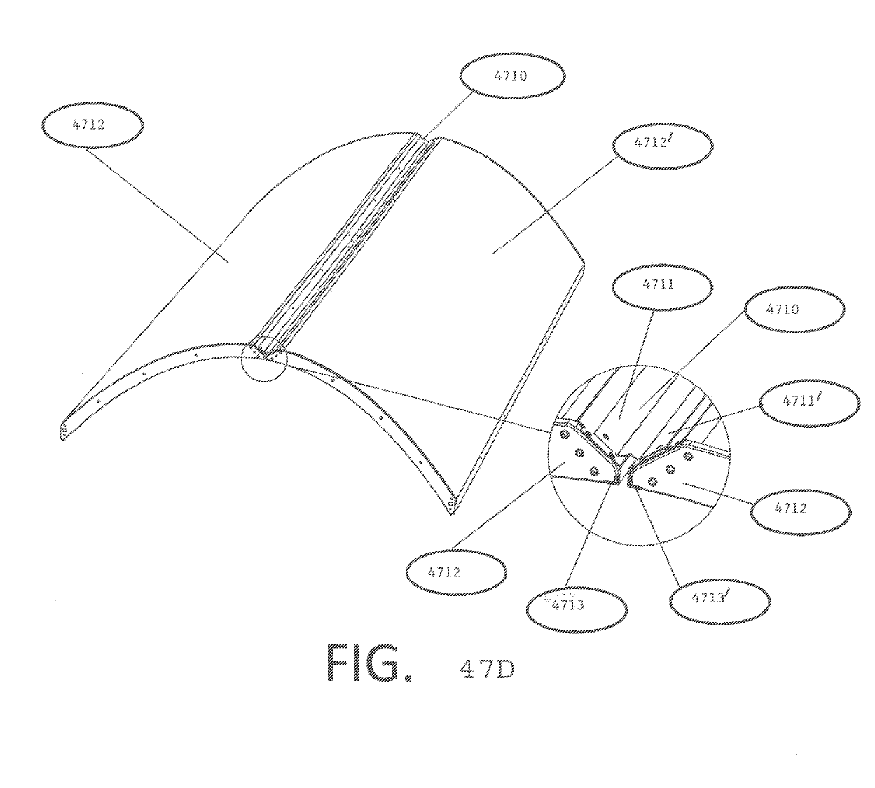

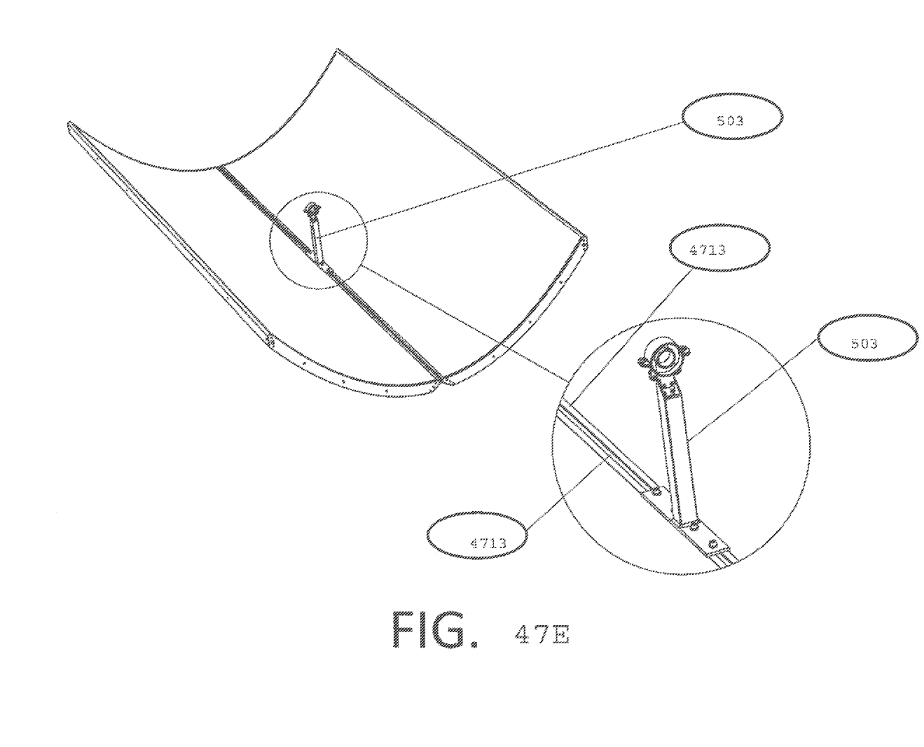

As shown in the figures, a wing interconnect such as a clip (502 (FIG. 5), 4701 (FIG. 47), 2803 (FIG. 28-30)) (e.g. an H-clip) may be used to attach two arc-shaped reflectors 501, 2802 together at the bottom of a parabola by connecting bottom cowling of one arc-shaped reflector to bottom cowling of the opposite reflector. A clip such as an H-clip may therefore have two sets of arms, one set that engages one arc-shaped reflector and one set that engages the other arc-shaped reflector.

A clip 502, 4701,2803 or other interconnect may also optionally have a provision for attaching a stanchion 1401, 2808 to support the receiver tube 1301 and glass envelope 2001. The stanchion 1401, 2808 may be positioned on top of the H-clip 4701 in the center of collector. This allows the stanchion 1401 to remain stationary and ensures the receiver tube 1301 is always centered at the focal point of the collector.

A clip as used in the collector depicted in FIG. 28-30 may not have the exact shape of an “H” as the H-clip of FIG. 47 has. A clip 3701, 3702 in this instance may have a cross-section similar to that depicted in FIG. 37A or 37B and be generally H-shaped.

The fastener or interconnect need not be a clip. For instance, a fastener may be a screw that joins flat tabs from adjoining cowling together or a latch and receiving portion on adjacent panels, for instance.

The fastener may be a longeron that extends at least about 50% of the length of the reflectors or their cowling that are interconnected. A clip may span some or a longeron essentially all of the distance from one end cap to the other end cap. Since a clip need only provide an attachment point to improve rigidity of the assembly, a clip may be relatively short, being less than about 1/10 of the length of the cowling with which it engages. If further rigidity is desired, the clip can be made longer. The clip may be positioned at a midpoint along the longitudinally extending cowling for instance, or multiple clips may be positioned approximately equidistantly along the longitudinally extending cowling. A longeron is especially useful where the solar energy collector (or other structure being formed) has a large area or aperture and where plural collectors are ganged together and driven by a common motor.

FIG. 47D illustrates interconnect 4710 as a winged longeron with two wings, one wing 4711 that engages one arc-shaped reflector 4712 and one wing 4711′ that engages the other arc-shaped reflector 4712′. In this particular instance, longeron spans from one end cap to the other end cap to provide rigidity to the wings. The interconnect may be affixed between opposing bottom cowlings by a screw, bolt, adhesive, or other fastening. The interconnect may or may not have flanges 4713, 4713′ that extend about parts of the reflector wings on the reflective side. The interconnect may optionally have fastening areas such as fastener holes where a stanchion 503 may be affixed, as illustrated in FIG. 47E.

A first alternative embodiment of the interconnect 4704 comprises a receiver cowling 4705 and connector cowling 4706. Both the receiver cowling 4705 and the connector cowling are made by extruding metal, such as aluminum, plastic or other sufficiently rigid materials.

When two arc-shaped reflectors are attached using the first alternative embodiment of the interconnect 4702, the receiver cowling 4705 is attached to the bottom edge of one arc-shaped reflector and the connector cowling 4706 is attached to the bottom edge of the other arc-shaped reflector. The dovetail tab 4708 is then slid down the dovetail way 4707 until the two arc-shaped reflectors align.

A second alternative embodiment of the interconnect 4709 is a single extrusion forming double bottom cowling.

The second alternative embodiment of the interconnect 4709 affixes to the bottom edge of two arc-shaped reflectors by screw, bolt, adhesive or any other fastener method.

13. Longitudinal Collector Tube

As shown in FIG. 13 and FIG. 28-29, a longitudinal collector tube 1301, 2801 similar to that described in prior patent applications incorporated by reference above, may be positioned with the parabola to receive light and solar thermal energy reflected by a parabolically-shaped reflective panel of a solar energy collector.

The collector or receiver tube 1301, 2801 may have a working fluid, preferably an oil, Freon or water, working through the interior of the pipe. The receiver tube 1301 may connect to a joint or pass through a locator tube collar 2301 (FIG. 23) (3312 of hub 3304 in FIG. 33) and locator tube 2201 (FIG. 22) joined to a stand 2401 (FIG. 24) that supports the support structure. Each support structure may have its own receiver tube 1301, 2801 that joins to adjacent receiver tubes through joints, hoses, or other types of connectors typically used in joining tubes that will undergo thermal expansion and contraction. Alternatively, a single receiver tube 1301, 2801 may be used for ganged support structures or for two or three adjacent support structures. A support structure may have one or more stanchions 1401, 2808 to support the receiver tube, as explained in further detail below. The receiver tube may be painted with black paint or coated with a coating that absorbs solar energy and transmits the resultant heat to the tube wall. If the trough solar energy collector has an axis of rotation coaxial with the collector tube, the collector tube may be configured to rotate with the trough solar energy collector, or the collector tube may be fixed in position so that the trough collector rotates about the stationary collector tube. If the axis of the collector tube does not coincide with the rotational axis of the trough solar energy collector, the collector tube may revolve about the axis of rotation of the trough solar energy collector.

14. Stanchion

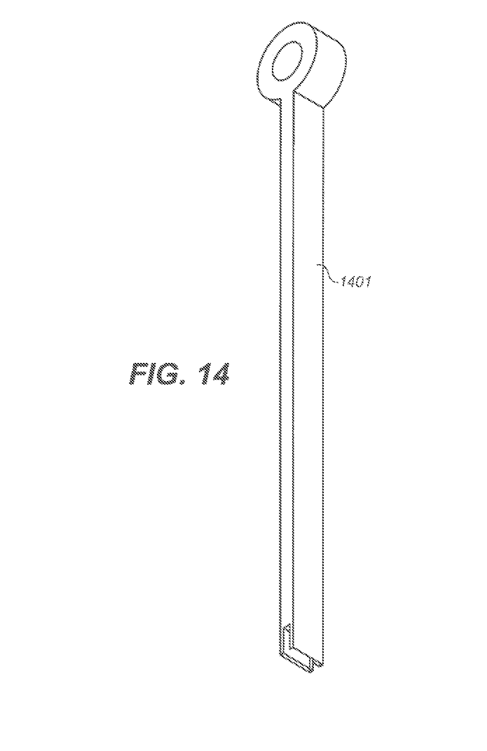

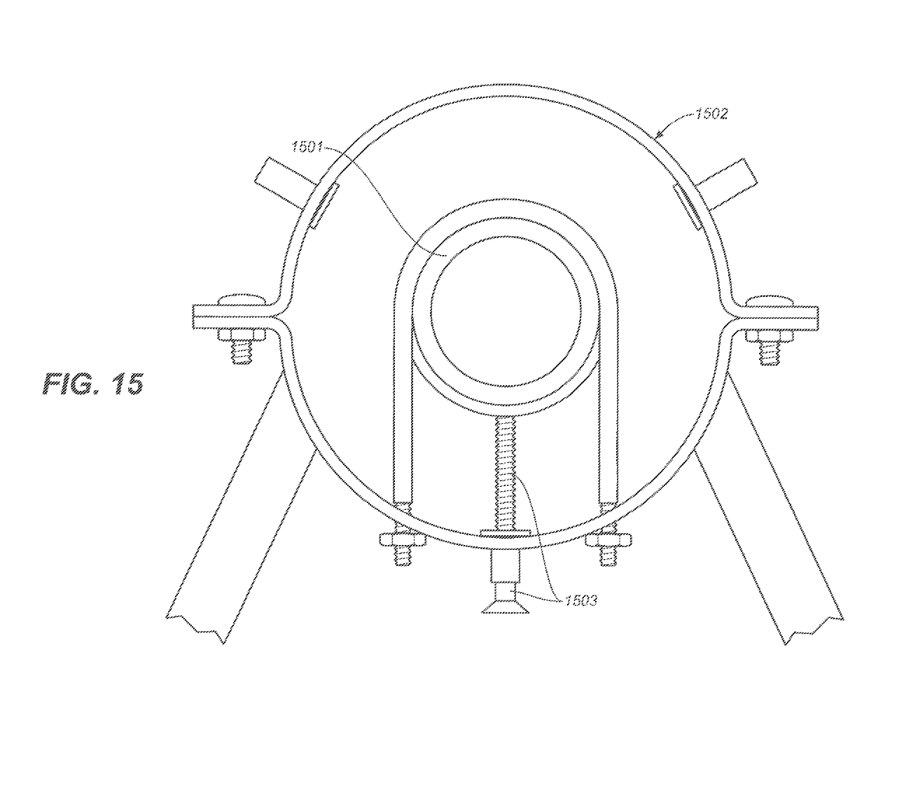

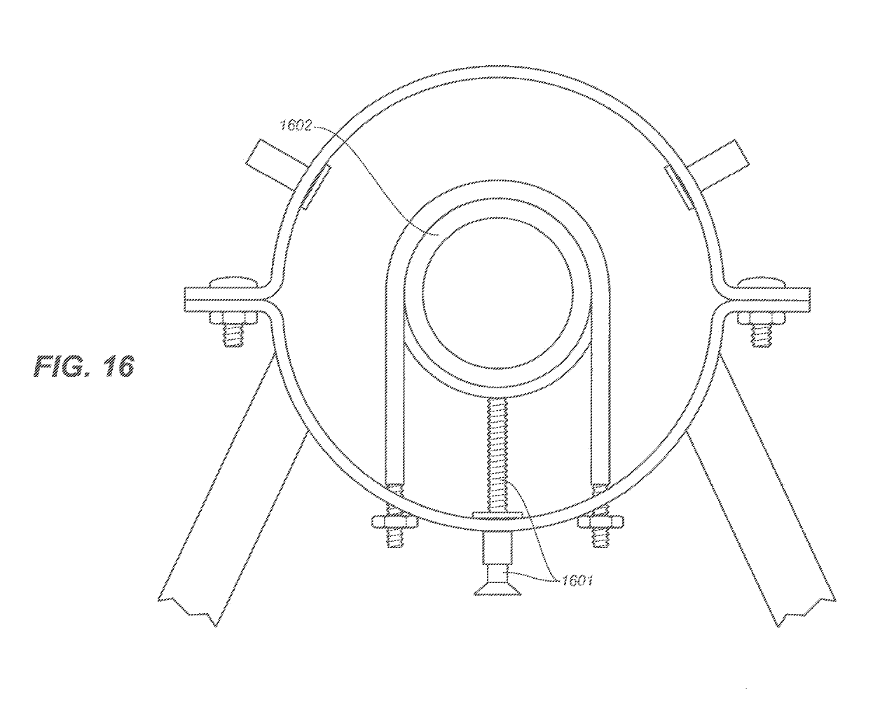

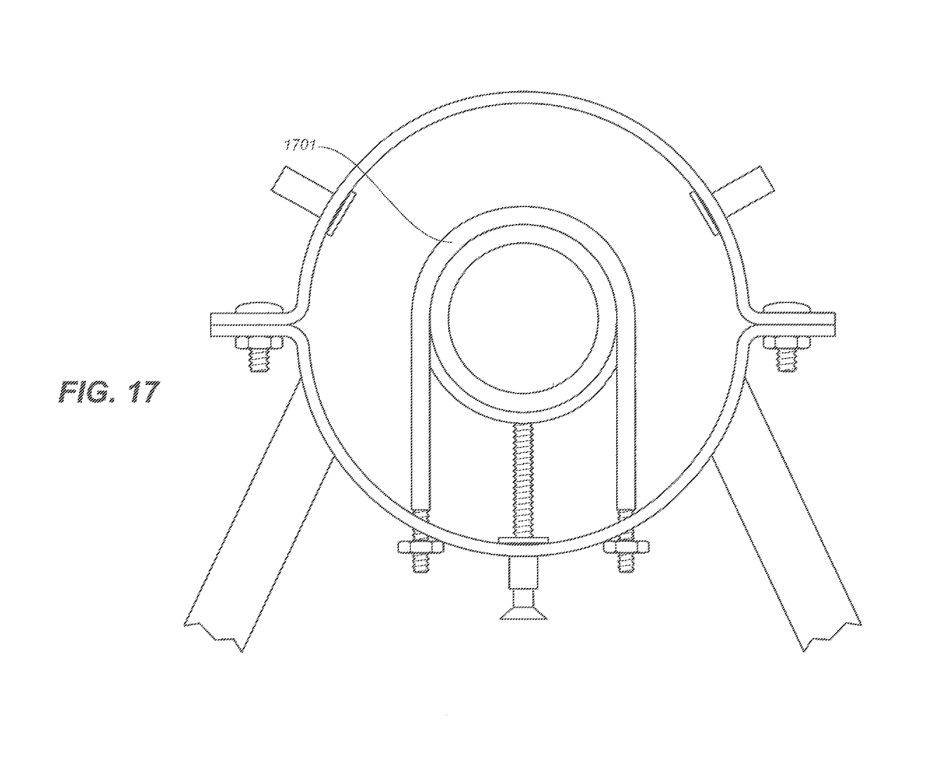

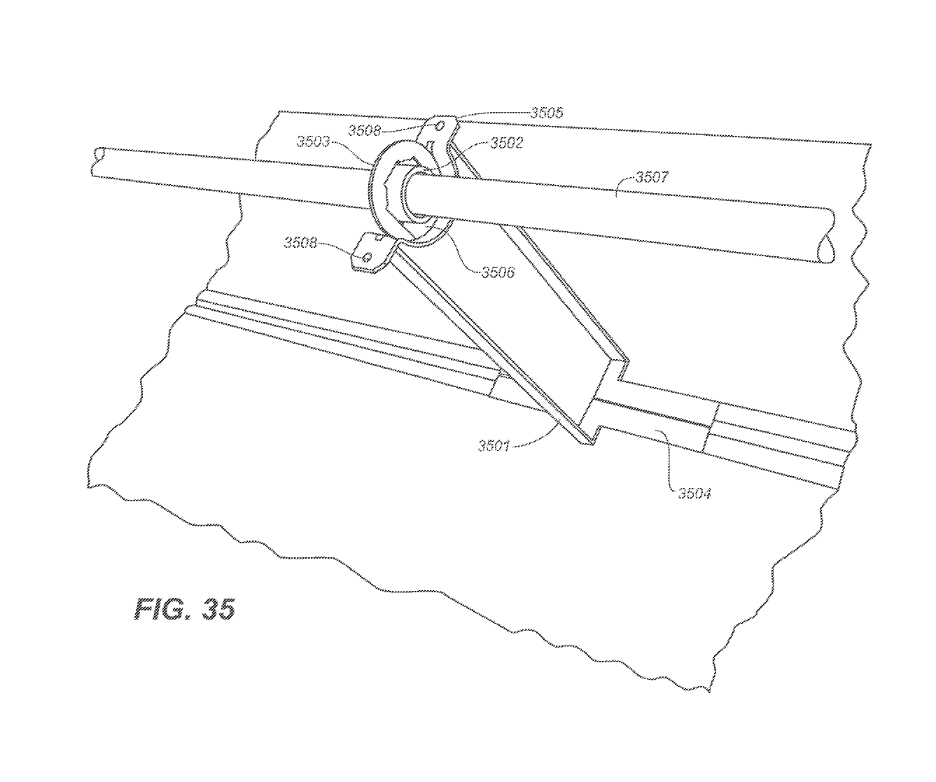

As shown in FIG. 14 and FIG. 35, one or more stanchions 1401,3501 similar to those described in prior patent applications incorporated by reference above, may be used to support a longitudinal receiver tube 1301 by means of a bearing (FIG. 15 1501, FIG. 35 3502) and bearing attachment (FIG. 17 1702, FIG. 35 3503) as explained in further detail below, as well as to support the glass envelope 2001 described below. One or more two-leg stanchions and/or single-leg stanchions 1401 are positioned between transverse end arms 901 and may attach to the arc-shaped reflector panel. The stanchion 1401, 3501 may be positioned on top of or formed as part of a clip 1201, 3504 in the center of the collector to keep it stationary and ensure the receiver tube 1301 is always centered at the focal point. A stanchion 1401, 3501 may be made of any suitable rigid material. preferably aluminum, stainless steel, or the like, may have adjustment screws 1503 or bolts or plastic screws, explained below, which can be adjusted to provide better reflective focus across the collector.

Collector tube height can be adjusted by moving the plate 3506 on which the bearing rests up or down and then tightening the bearing attachment 3503 to secure the collector tube 3507 and bearing 3502 in place. An additional cap (not shown for sake of clarity) engages with bolt-holes 3508 onto the stanchion to retain an insulating glass envelope (discussed below).

15. U-Bolt Assembly

As shown in FIGS. 15-18, a U-bolt assembly may be used to fasten the receiver tube bearing 1501, described below, to the stanchion 1401. thereby allowing for adjustability of the receiver tube 1301. The U-bolt assembly shown in FIGS. 15-18, which is secured by nuts, extends in a “U” shape through the bottom of the stanchion 1401, around the receiver tube bearing 1501, and back through the other side of the stanchion. Additionally, there may be a bolt extending through the bottom of a bracket where the “U” bolt is attached. This allows for height adjustments of the receiver tube bearing 1501 centering the receiver tube 1301.

16. Receiver Bearing Adjustment Screw

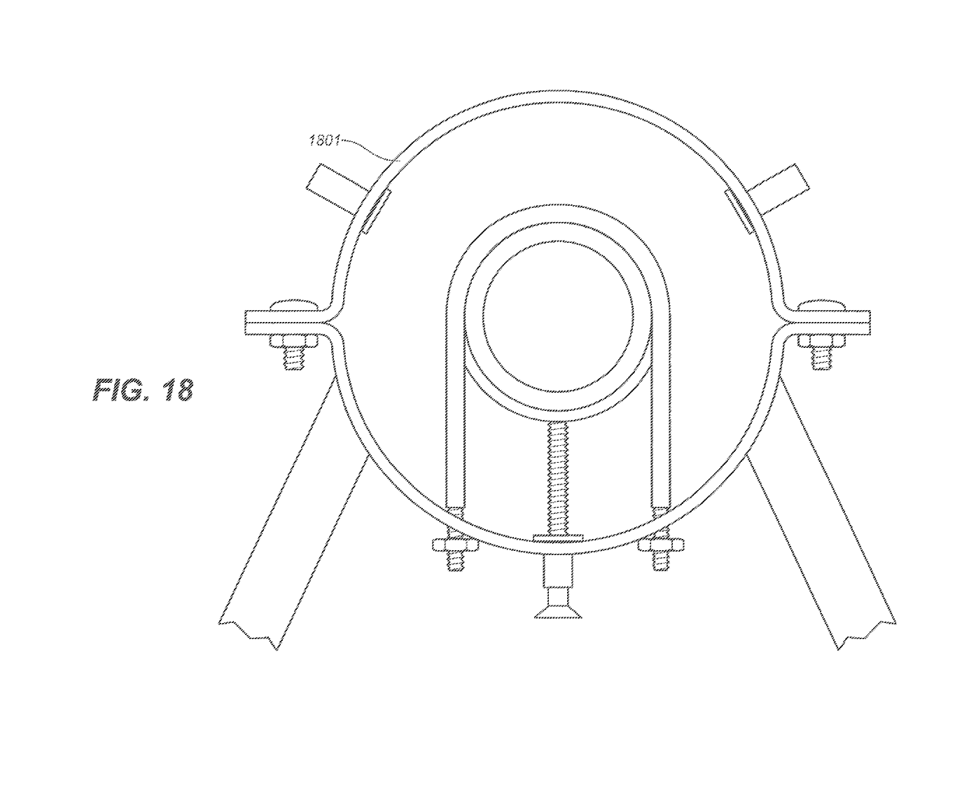

As shown in FIGS. 15 and 16, stanchions may have adjustment screws 1503 and 1601 or bolts or plastic screws that can be adjusted to provide better reflective focus across the collector. Adjustment screws 1503 and 1601 may adjust the height of the receiver tube bearing 1602 to provide optimal reflective focus across the length of the collector, thereby increasing collector efficiency.

17. Receiver Tube Bearing Attachment

As shown in FIG. 17, a receiver tube bearing attachment 1701 may be used to accommodate the thermal expansion and contraction of the receiver tube 1301. The bearing attachment 1701 permits the panels to rotate around the receiver tube 1301 and position the receiver tube 1301 to ensure maximum reflective focus and collector efficiency. This allows the receiver tube 1301 to slide longitudinally as the receiver tube 1301 expands and contracts.

18. Stanchion Bracket

As shown in FIGS. 18 and 33, stanchion brackets 1801, 3303, 3305 may be used to support the glass envelope 2001, described below. The brackets 1801, 3303, 3305 may be made of any suitable rigid material, preferably aluminum, stainless steel, or otherwise, clamp together to compress against the glass and provide support across the length of the glass envelope 2001. An additional cap (not shown for sake of clarity) engages with bolt-holes 3508 on the stanchion bracket 3505 to retain an insulating glass envelope.

19. Gaskets

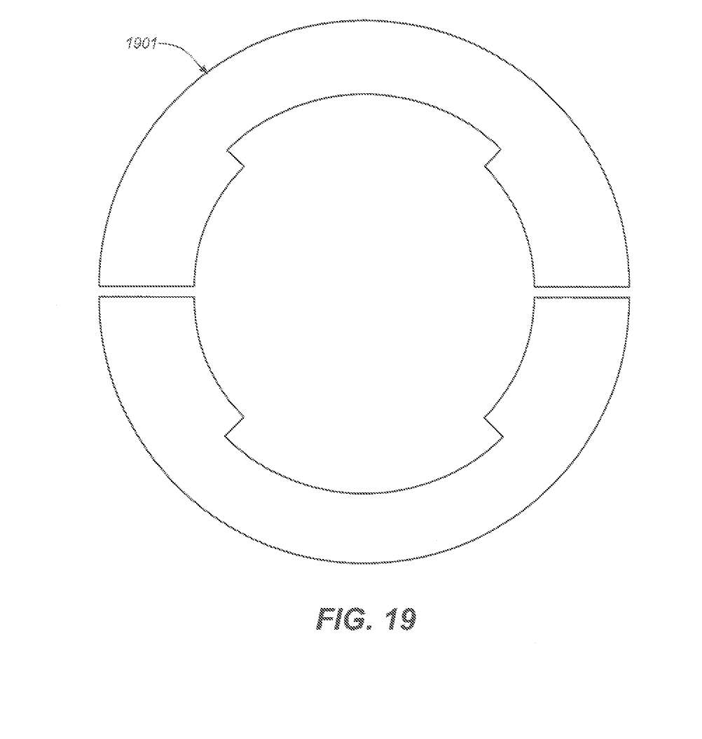

As shown in FIG. 19, silicone 1901, preferably, or another resilient polymer, organic or inorganic gel, ceramic or metals able to withstand high temperatures as described in prior patent applications incorporated by reference above, may be used to support the glass envelope 2001 and serve as an end seal. The silicone foam gaskets 1901 are placed at the ends of the glass envelope 2001 between the receiver tube 1301 and the glass and are clamped down by a bracket secured with bolts.

The seal created contains the ambient atmosphere within the chamber of the glass envelope 2001 when a cover, described below, is placed on or in the opening of the glass envelope 2001 housing. The silicone end seals 1901 may be pliable and movable to allow thermal expansion without undue stress being created on the ends of the glass envelope 2001 or the receiver tube 1301.

20. Glass Envelope

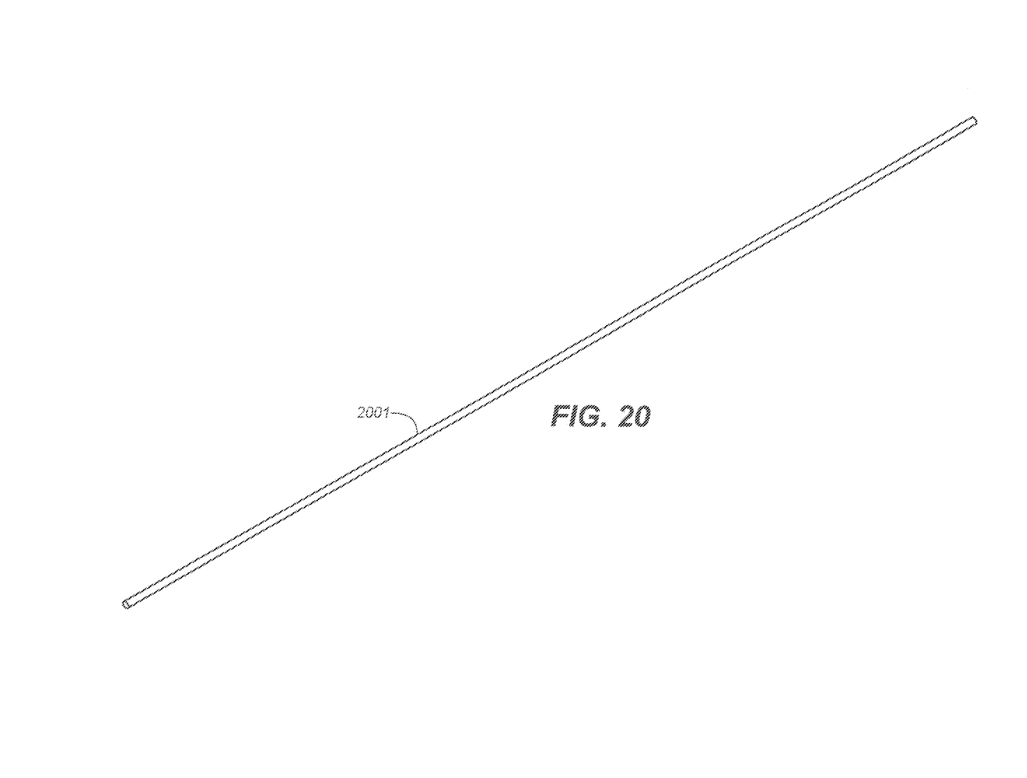

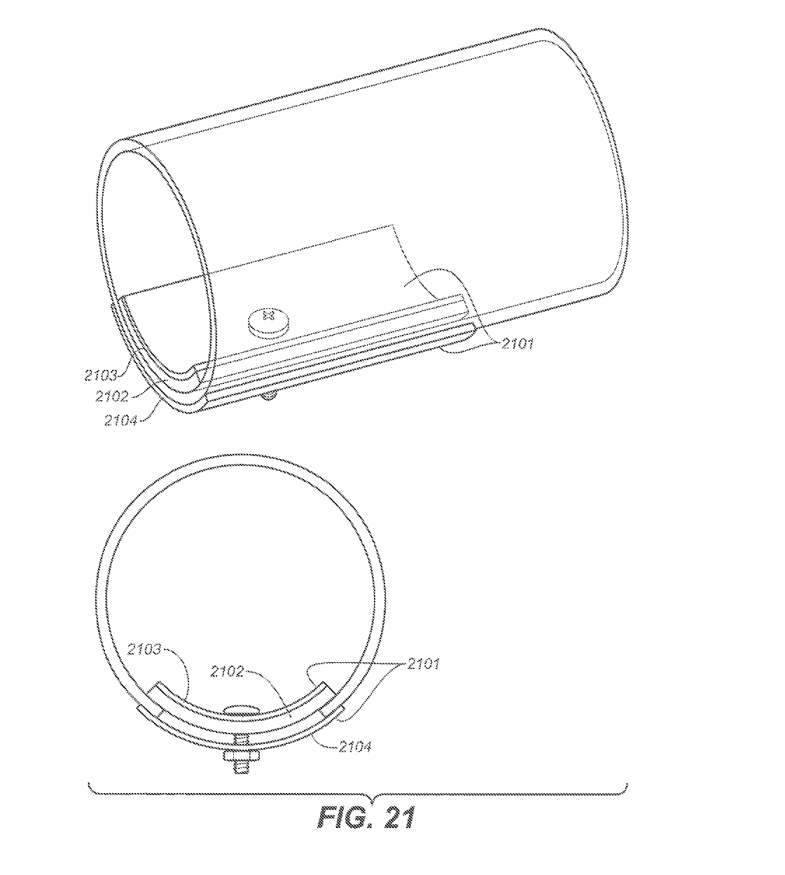

As shown in FIG. 20, the glass envelope 2001, a transparent tubular housing similar to those described in prior patent applications incorporated by reference above, may be used to enclose the receiver tube 1301 to provide an insulating layer and reduce heat loss. The glass envelope 2001 may vary in thickness, preferably around 2 millimeters thick and may have a chamber that is sufficiently large to contain the receiver tube 1301 positioned within the glass chamber. The glass envelope 2001 may be transparent to UV, visible, and/or infrared light. Preferably, the glass envelope 2001 is transparent to at least the sun's visible and infrared radiation. The envelope 2001 may be formed from borosilicate glass such as Pyrex. Alternatively, the envelope 2001 may be formed of an acrylic polymer such as polymethacrylate, a butyrate, a polycarbonate, or other polymer that admits at least 70% of the sunlight 14 incident upon it. The glass envelope 2001 may contain air, other gases, or be evacuated or partially evacuated in some variations.

Additionally, the glass envelope 2001 may be sliced to shape leaving at least one opening to allow easy access to the chamber, so the envelope 2001 may be placed over the receiver tube 1301 without having to slide it on and risk breakage. This opening allows for convenient and easy installation, assembly, replacement, and cleaning. The one or more openings may run the entire length of the glass envelope 2001 and may be as wide as or wider than the receiver tube 1301 that is to reside within the chamber of the envelope 2001. Once placed over the receiver tube 1301, the glass envelope 2001 opening may be filled with an inner and outer reflective cover 2101 described below, and an insulating material 2102, all of which are sealed by the silicone foam gaskets 1901.

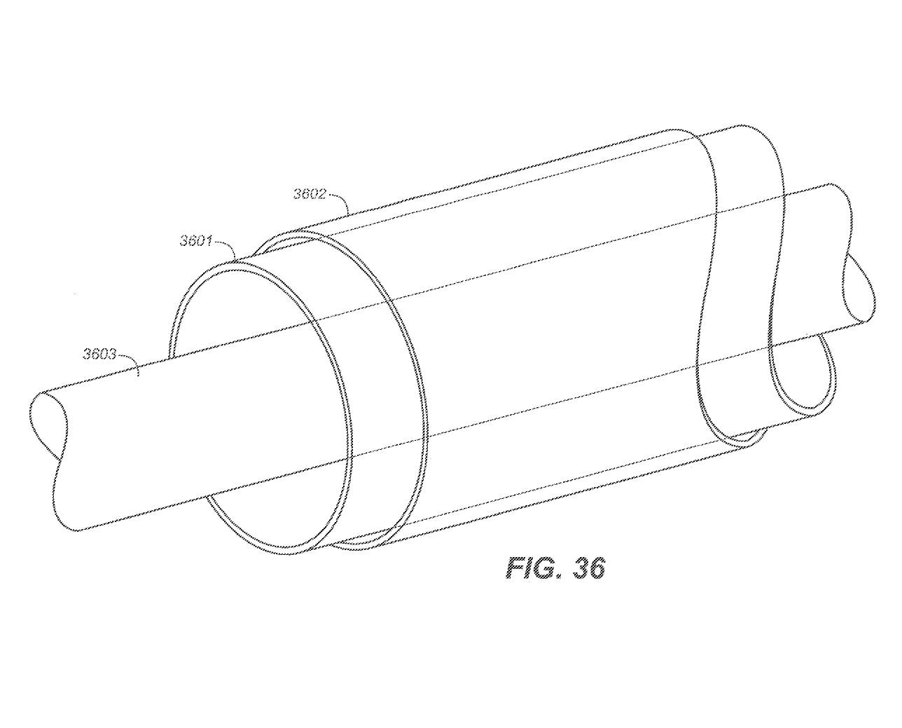

A glass envelope may be a telescoping envelope as illustrated in FIG. 36. One glass tube 3601 nests within a second glass tube 3602 around a collector tube 3603. During collector assembly, the nested tubes are placed over the collector tube, and subsequently the outer glass tube is slid along the inner glass tube so that one of the tubes can be secured to a side of the stanchion and the other of the glass tubes can be secured to or in the vicinity of the locator tube collar 3312 of the hub 3304 of FIG. 33.

21. Inner and Outer Reflective Cover

As shown in FIG. 21, a cover assembly, similar to that described in prior patent applications incorporated by reference above, may be placed on or in the glass envelope 2001 opening, and may or may not be retractable. The cover assembly may consist of an inner and outer cover 2101, as well as insulating material 2102. The cover assembly may be attached in a manner to allow the cover be retractable for venting and cleaning of the glass envelope 2001.

The inner and outer covers 2101 are often movable and may fit within or upon the one or more openings of the glass envelope 2001. The inner and outer covers 2101 may be made of any suitable rigid material, preferably aluminum (polished or unpolished), may be formed of a metal such as stainless steel that has high rigidity, or may be silvered to make a reflective surface. The outer cover 2104 may provide a protective backing for the glass envelope 2001. The inner cover 2103 acts as a lens to better direct solar radiation onto the receiver tube 1301. The inner cover 2103 focuses solar energy upon the receiver tube 1301 when it is seated in the glass envelope 2001 and reflects any solar radiation that is not reflected directly onto the receiver tube 1301. The inner cover's 2103 surface may reflect at least 50% of the radiation incident upon it, and preferably the surface reflects greater than 80% or 90% of the radiation incident upon it. Inserted in between the inner and outer cover 2101 is a thermally insulating material 2102 able to withstand high temperatures, preferably a rigid polymer like polycarbonate, polyamide, or polyimide that may have a mirrored coating to reflect light. The insulating material 2102 and the inner and outer covers 2101 may be clamped together by a bolt, screw, rivet, or any other suitable fastener.

22. Locator Tube

As shown in FIG. 22, a locator tube 2201, similar to that described in prior patent applications incorporated by reference above, may be used to support a solar collector, as well as to join two solar collectors together. The tube 2201, which extends through an end arm 901, may be made of any suitable rigid material, preferably aluminum (polished or unpolished) or a metal such as stainless steel that has high rigidity. In addition, the locator tube 2201 rests on a stand 2401, described below, allowing it to rotate around the receiver tube 1301. The locator tube 2201 may also contain a keyway or a key which allows it to drive the locator tube collar 2301 described below.

The locator tube 2201 and locator tube collar 2301 may each have holes through which bolts or adjusting screws, for example, extend. The bolts or screws secure the locator tube collar 2301 and locator tube 2201 so that they rotate in unison. Additionally, the bolts or screws may extend through the holes to support the receiver tube 1301 and the locator tube may be used as a race for the bearing to allow the receiver tube 1301 to pass through.

23. Stand

As shown in FIG. 24, a support structure is typically secured to stands 2401 containing bearings, similar to those described in prior patent applications incorporated by reference above, to allow the support structure to pivot along an axis defined by the bearings. The stand 2401 may be made of aluminum (polished or unpolished) or a metal such as stainless steel that has high rigidity. The stand 2401 may have a locator tube 2201 extending through the bearing at either or both ends of the bearing and extending into a locator tube collar 2301 of the support structure, thereby providing a more rigid structure.

24. Torsion Cables

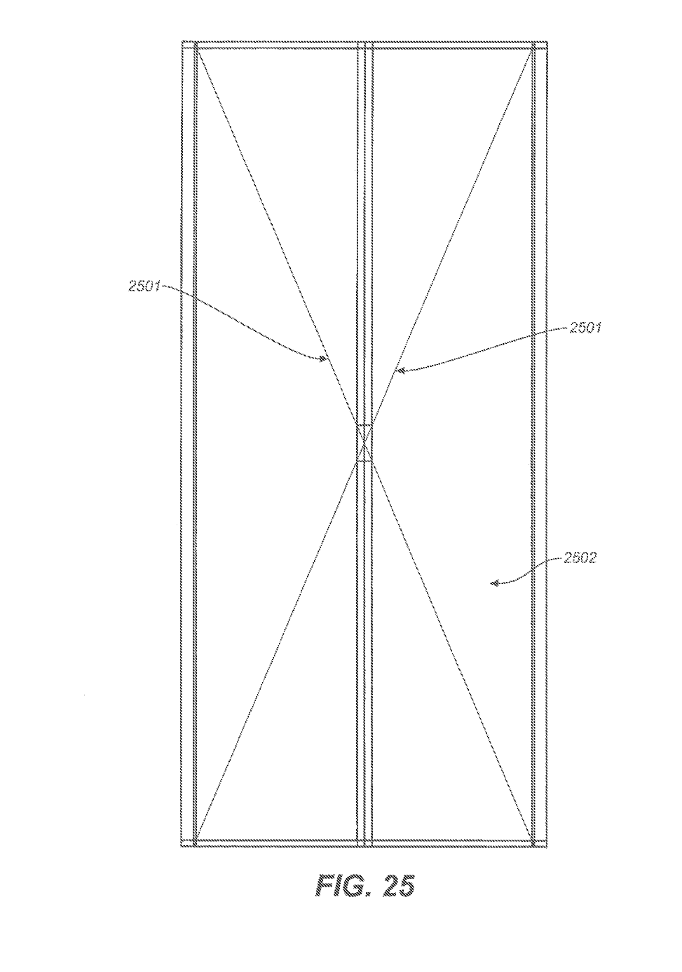

As shown in FIG. 25, the support structure 2502 may have optional torsion cables 2501, similar to those described in prior patent applications incorporated by reference above, that may extend diagonally from one end arm to the opposite end arm of the support structure 2502. The torsion cables 2501 may therefore cross in an “X”-shaped configuration, for instance. The torsion cables 2501 help provide a rigid structure that resists torsion without adding significant weight to the support structure or shading to the solar panels or reflective element.

The following is disclosed by way of example and not by way of limitation:

1. A trough solar energy collector having a rotational axis comprising

a. a collector tube,

b. a reflective panel or a plurality of reflective panel,
i. each of said reflective panels comprising,
   (1) an internal structure having an arc-shaped surface,
   (2) a reflector on the arc-shaped surface.
ii. the reflector panel being positioned to illuminate a collector tube,
   2. The collector according to paragraph 1 wherein the collector tube is coincident with the rotational axis of the solar collector.
   3. A collector according to any paragraphs of 1-2 and further comprising end arm comprising
a. a hub fitting having an opening through which the collector tube passes,
b. a plurality of arm end fitting configured to engage with the top portions of the reflective panel,
c. an arm bottom fitting configured to engage with the bottom portions of the reflective panel, and
d. a plurality of fitting couplers securing the plurality of arm end fittings and arm bottom fittings to the hub fitting.
   4. A collector according to paragraph 3 wherein the hub fitting has a collar at said opening to engage with locator tube of the collector and means for securing the collar to the locator tube.
   5. A collector according to any of paragraphs 3-4 wherein the hub fitting has holes extending radially from the hub fitting to engage ends of the fitting couplers.
   6. A collector according to any of paragraphs 3-5 wherein the arm end fittings have collar portions into which edges of the reflective panels insert.
   7. A collector according to any of paragraphs 3-6 wherein the arm end fittings or the reflective panels have openings and the other of the arm end fittings or the reflective panels have shapes that insert into openings to engage the arm end fittings with the reflective panels.
   8. A collector according to any of paragraphs 3-7 wherein the arm bottom fitting or the reflective panels have openings and the other of the arm bottom fitting or the reflective panels have shapes that insert into the openings to engage the arm bottom fitting with the reflective panels.
   9. A collector according to any of paragraphs 3-8 wherein the arm bottom fitting has a collar portion into which edges of the reflective panels insert.
   10. A collector according to any of paragraphs 3-9 wherein a plurality of the fitting couplers interconnect the hub fitting with the end arm fitting.
   11. A collector according to any of paragraphs 3-10 wherein a plurality of the fitting couplers interconnect the hub fitting with the arm bottom fitting.
   12. A collector according to any of paragraphs 3-11 wherein the fitting couplers are rods.
   13. A collector according to any of paragraphs 3-12 wherein said rods between the hub fitting and the arm end fittings and the rods between the hub fitting and the arm bottom fittings are cut or formed to lengths to create a scalable aperture width for the collector with a common rim angle.
   14. An end arm in assembled or disassembled form comprising
a. a hub fitting having an opening through which the collector tube passes,
b. a plurality of arm end fitting configured to engage with the top portions of the reflective panel,
c. an arm bottom fitting configured to engage with the bottom portions of each of the reflective panel, and
d. a plurality of fitting couplers securing the plurality of arm end fittings and end bottom fittings to the hub fitting.
   15. An end arm according to paragraph 14 wherein the hub fitting has a collar at said opening to engage with locator tube of the collector and means for securing the collar to the locator tube.
   16. An end arm according to any of paragraphs 14-15 wherein the hub fitting has holes extending radially from the hub fitting to engage ends of the fitting couplers.
   17. An end arm according to any of paragraphs 14-16 wherein the arm end fittings have collar portions into which edges of the reflective panels insert.
   18. An end arm according to any of paragraphs 14-17 wherein the arm end fittings have openings or shapes to engage with corresponding shapes or openings on reflective panels allowing the arm end fitting to engage with the reflective panels.
   19. An end arm according to any of paragraphs 14-18 wherein the arm bottom fitting has openings or shapes to engage with corresponding shapes or openings on reflective panels allowing the arm bottom fitting to engage with the reflective panels.
   20. An end arm according to any of paragraphs 14-19 wherein the arm bottom fitting has a collar portion into which edges of the reflective panels insert.
   21. An end arm according to any of paragraphs 14-20 wherein a plurality of the fitting couplers interconnect the hub fitting with the arm end fitting.
   22. An end arm according to any of paragraphs 14-21 wherein a plurality of the fitting couplers interconnect the hub fitting with the arm bottom fitting.
   23. An end arm according to any of paragraphs 14-22 wherein the fitting couplers are tubes.
   24. A collector according to any of paragraphs 14-23 wherein said tubes between the hub fitting and the arm end fittings and the tubes between the hub fitting and the arm bottom fittings are cut or formed to lengths to create a scalable aperture width for the collector with a common rim angle.
   25. A method of assembling a collector comprising

a. an arc-shaped reflectors,

b. affixing end arms any of paragraphs 1-13 to said arc-shaped reflectors.

26. A method of assembling a collector comprising

a. an arc-shaped reflectors,

b. affixing end arms any of paragraphs 14-24 to said arc-shaped reflectors.

Also disclosed herein is, by way of example and not by way of limitation,

1. A trough solar energy collector having a rotational axis comprising
a. a collector tube,
b. a first reflective panel and a second reflective panel,
   i. each of said first and second reflective panels comprising
      (1) a honeycomb or polymeric core having an arc-shaped surface
      (2) a reflector on the arc-shaped surface of the core
      (3) top and bottom cowlings along a longitudinal edge extending along the core and extending parallel to the rotational axis of the solar collector
   ii. the first reflector panel being positioned to illuminate a first side of the collector tube,
   iii. the second reflector panel being positioned to illuminate a second side of the collector tube.
c. an interconnect running longitudinally between said first and second reflective panels
   2. The collector according to paragraph 1 wherein the collector tube is coincident with the rotational axis of the solar collector.
   3. The collector according to paragraphs 1-2 wherein a portion of the cowling overlies and edge of the reflector to aid in securing the reflector to the core.
   4. The collector according to paragraphs 1-3 wherein an interconnect being positioned between the first reflective panel and a second reflective panel such that the interconnect engages the structure of the first reflective panel and the structure of the second reflective panel.
   5. The collector according to paragraph 4 wherein said interconnect is a winged-longeron having a first and a second wing and positioned between the first reflective panel and the second reflective panel such that the first wing engages a land of the bottom cowling of the first reflective panel and the second wing engages a land of bottom cowling of the second reflective panel.
   6. The collector according to paragraph 5 wherein the interconnect further comprises a stanchion that supports the collector tube.
   7. The collector of paragraph 5 wherein the interconnect is extruded metal.
   8. The collector of paragraph 1 wherein said interconnect is an integral part of the bottom cowling of the first reflective panel and a separate integral part of the bottom cowling of the second reflective panel.
   9. The interconnect of paragraph 8 comprises a dovetail tab integrally affixed to the bottom cowling of the first reflective panel and a dovetail way integrally affixed to the bottom cowling of the second reflective panel.
   10. The dovetail tab and dovetail way of paragraph 9 interlock to secure the first reflective panel to the second reflective panel.
   11. The collector according to paragraph 8 wherein the said interconnect further comprises a stanchion that supports the collector tube.
   12. The interconnect of paragraph 8 wherein the dovetail tab and dovetail way are extruded metal.
   13. The collector of paragraph 1 wherein said interconnect is an integral part of both the first reflective panel and the second reflective panel.
   14. The interconnect of paragraph 13 comprises a double bottom cowling affixed to both the first reflective panel and the second reflective panel.
   15. The collector according to paragraph 13 wherein the said interconnect further comprises a stanchion that supports the collector tube.
   16. The interconnect of paragraph 13 wherein the double bottom cowling is extruded metal.
   17. A method of assembling a concentrating solar energy collector, the method comprising a) a first and second reflector joined by interconnect of paragraph 5; b) where the said interconnect is screwed, bolted or affixed by adhesive to the bottom cowlings of the first and second reflectors; and c) a stanchion may be screwed or bolted to the interconnect.
   18. A method of assembling a concentrating solar energy collector, the method comprising a) a first and second reflector joined by interconnect of paragraph 8; b) where the said interconnect is screwed, bolted or affixed by adhesive to the bottom cowlings of the first and second reflectors; c) the first and second reflectors with the said interconnects affixed are slid together along the dovetail tab and dovetail way until the first and second reflectors align; and d) a stanchion may be screwed or bolted to the interconnect assembly.
   19. A method of assembling a concentrating solar energy collector, the method comprising a) a first and second reflector joined by interconnect of paragraph 13; b) where the said interconnect is screwed, bolted or affixed by adhesive to the first and second reflectors simultaneously; and c) a stanchion may be screwed or bolted to the interconnect.

In addition, disclosed herein by way of example and not limiting of the scope of invention is:

1. A trough solar energy collector having a rotational axis comprising

a. a collector tube,

b. a reflective panel or a plurality of reflective panels,
i. each of said reflective panels comprising,
   (1) an internal structure having an arc-shaped surface,
   (2) a reflector on the arc-shaped surface,
ii. said reflector panel being positioned to illuminate a collector tube.
   2. The collector according to paragraph 1 wherein the collector tube is coincident with the rotational axis of the solar collector.
   3. A collector according to any paragraphs of 1-2 and further comprising a sprocket drive comprising
a. a hub fitting having an opening through which the collector tube passes,
b. a plurality of arm end fittings configured to engage with the top portions of the reflective panel,
c. a plurality of arm bottom fittings configured to engage with the bottom portions of the reflective panel,
d. a plurality of fitting couplers securing the plurality of arm end fittings and arm bottom fittings to the hub fitting,
e. a plurality of load-transfer brackets configured to engage with the top and bottom fitting couplers,
f. a sprocket configured to engage with a plurality of load-transfer brackets and the arm bottom fitting, and
g. a motor drive attached to the sprocket by means of a chain, belt or other known method of imparting torque.
   4. A collector according to paragraph 3 wherein the hub fitting has a collar at said opening to engage with locator tube of the collector and means for securing the collar to the locator tube.
   5. A collector according to any of paragraphs 3-4 wherein the hub fitting has holes extending radially from the hub fitting to engage ends of the fitting couplers.
   6. A collector according to any of paragraphs 3-5 wherein the arm end fitting has an attachment interface to the reflective panel.
   7. A collector according to any of paragraphs 3-6 wherein the arm bottom fitting has an attachment interface to the reflective panel.
   8. A collector according to any of paragraphs 3-7 wherein the arm bottom fitting has an attachment interface to the sprocket.
   9. A collector according to any of paragraphs 3-8 wherein a plurality of the bottom fitting couplers interconnect the hub fitting with the arm bottom fitting.
   10. A collector according to any of paragraphs 3-9 wherein a plurality of the top fitting couplers interconnect the hub fitting with the end arm fitting.
   11. A collector according to any of paragraphs 3-10 wherein the top fitting coupler has an attachment interface to the load-transfer bracket.
   12. A collector according to any of paragraphs 3-11 wherein the sprocket has an attachment interface to a plurality of load-transfer brackets.
   13. An sprocket drive in assembled or disassembled form comprising
a. a hub fitting having an opening through which the collector tube passes,
b. a plurality of arm end fittings configured to engage with the top portions of the reflective panel,
c. a plurality arm bottom fittings configured to engage with the bottom portions of each of the reflective panel,
d. a plurality of fitting couplers securing the plurality of arm end fittings and end bottom fittings to the hub fitting,
e. a plurality of load-transfer brackets configured to engage with top and bottom fitting couplers,
f. a plurality of sprocket sections that are joined together to form a sprocket.
g. a sprocket is then configured to engage with a plurality of load-transfer brackets and the arm bottom fitting, and
h. a motor drive attached to the sprocket by means of a chain, belt or other known method of imparting torque.
   14. An end arm according to paragraph 13 wherein the hub fitting has a collar at said opening to engage with locator tube of the collector and means for securing the collar to the locator tube.
   15. An end arm according to any of paragraphs 13-14 wherein the hub fitting has holes extending radially from the hub fitting to engage ends of the fitting couplers.
   16. An end arm according to any of paragraphs 13-15 wherein the arm end fitting has an attachment interface to the reflective panel.
   17. An end arm according to any of paragraphs 13-16 wherein the arm bottom fitting has an attachment interface to the reflective panel.
   18. An end arm according to any of paragraphs 13-17 wherein a plurality of the bottom fitting couplers interconnect the hub fitting with the arm bottom fitting.
   19. An end arm according to any of paragraphs 13-18 wherein a plurality of the top fitting couplers interconnect the hub fitting with the arm end fitting.
   20. An end arm according to any of paragraphs 13-19 wherein the top fitting coupler has an attachment interface to the load-transfer bracket.
   21. An end arm according to any of paragraphs 13-20 wherein the plurality of sprocket sections are joined to form a sprocket.
   22. An end arm according to any of paragraphs 13-21 wherein the said sprocket has an attachment interface to a plurality of load-transfer brackets.
   23. A method of assembling a sprocket drive comprising

a. an arc-shaped reflectors,

b. affixing sprocket drive any of paragraphs 1-12 to said arc-shaped reflectors.

24. A method of assembling a sprocket drive comprising

a. an arc-shaped reflectors,

b. affixing sprocket drive any of paragraphs 14-22 to said arc-shaped reflectors.

What is claimed:

1. A plurality of solar energy collector comprising a first solar energy collector and a second solar energy collector, the first solar energy collector having a first end arm and the second solar energy collector having a second end arm, the first end arm comprising a first hub, a first arm end fitting, a first arm end fitting coupler connecting the first arm end fitting with the first hub, a first arm bottom fitting, a first arm end fitting coupler connecting the first arm bottom fitting to the first hub; the second end arm comprising a second hub, a second arm end fitting, a second arm end fitting coupler connecting the second arm end fitting with the second hub, a second arm bottom fitting, a second arm end fitting coupler connecting the second arm bottom fitting to the second hub, wherein the first hub is identical to the second hub, wherein the first arm end fitting is identical to the second arm end fitting, wherein the first arm bottom fitting is identical to the second arm end fitting, and wherein the first arm end fitting coupler and the second arm end fitting-coupler are different and/or the first arm bottom fitting coupler and the second arm end fitting coupler are different.

2. The plurality of claim 1 wherein the first and second arm end fitting couplers are different in at least their length or the first and second arm bottom fitting couplers are different in at least their length or both.

3. The plurality of claim 1 wherein the first and second arm end fitting couplers are different in at least their strength against bending or the first and second arm bottom fitting couplers are different in at least their strength against bending or both.

4. The plurality of claim 3 wherein at least two of the couplers have different wall thicknesses.

5. The plurality of claim 1 wherein at least two of the couplers are different in at least their material of construction.

6. The plurality of claim 1 wherein the couplers are different in at least their compressive strength.

7. The plurality of claim 1 wherein the first solar energy collector is a first reflector and the second solar energy collector is a second reflector.

8. A kit for making a solar energy collector comprising the parts specified in claim 1 above.

9. A method of making end arms for supporting a solar energy collector, the method comprising forming at least a portion of a first end arm by coupling a first hub to a first arm end fitting using a first arm end fitting coupler, and forming at least a portion of a second end arm by coupling a second hub identical to the first hub to a second arm end fitting identical to the first arm end fitting using a second arm end fitting coupler, wherein the first arm end fitting coupler and the second arm end fitting coupler are not identical.

10. A method of making end arms for supporting a solar energy collector, the method comprising forming at least a portion of a first end arm by coupling a first hub to a first arm bottom fitting using a first arm bottom fitting coupler, and forming at least a portion of a second end arm by coupling a second hub identical to the first hub to a second arm bottom fitting identical to the first arm bottom fitting using a second arm bottom fitting coupler, wherein the first arm bottom fitting coupler and the second arm bottom fitting coupler are not identical.

11. A solar energy collector comprising a first solar energy collector, a second solar energy collector, and an interconnect comprising a clip or a longeron having a first wing, a second wing, a first flange, and a second flange, said first flange being shorter than said first wing, said second flange being shorter than said second wing (in a cross-sectional view of the interconnect), and wherein the first flange is mounted to a solar energy-collecting side of said first solar energy collector, wherein said first wing is mounted to a non-collecting side of said first solar energy collector, said second flange is mounted to a solar energy-collecting side of said second solar energy collector, and said second wing is mounted to a non-collecting side of the second solar energy collector.

12. A collector of claim 11 wherein the interconnect is extruded.

13. A collector of claim 11 wherein the interconnect is a longeron.

14. A collector of claim 11 wherein the interconnect comprises two pieces that interlock to form the interconnect.

15. A collector of claim 14 wherein the interconnect is interlocked through a dovetail joint.

16. A collector of claim 11 wherein the interconnect is a solid piece without cut or open space within the interconnect.

17. A solar energy collector having a sprocket that is an open sprocket not having reinforcing pieces formed of the sprocket material, which collector comprises a collector comprising the parts of claim 1 and having at least one end arm that reinforces the open sprocket.

18. A solar energy collector according to claim 17 wherein the sprocket is attached to the end arm in at least three regions on the sprocket.

19. A solar energy collector according to claim 18 wherein the distance from the first end arm fitting along the sprocket to the bottom fitting is equal to the distance from the second end arm fitting along the sprocket to the bottom fitting, and the distance from the first end arm fitting to the second end arm fitting along the sprocket in a direction not intersecting the bottom fitting is not equal to the distance from the first end arm fitting to the bottom fitting.

20. A solar energy collector according to claim 19 wherein the sprocket is connected to the first end arm fitting to hub connector and the second end arm fitting-to-hub connector by way of split sprocket brackets.

21. A solar energy collector according to claim 20 wherein a first piece of one of the split sprocket brackets is identical to a second piece of that split sprocket bracket.

22. A solar energy collector according to claim 17 and having a spacer between the bottom end fitting and the driven sprocket.

23. A collector according to claim 17 wherein the core is polymeric and comprises expanded polystyrene, extruded polystyrene, or expanded extruded polystyrene.

24. A collector according to claim 23 wherein the core is polymeric and the polymeric core is skinless.

25. A collector according to claim 17 wherein the core is polymeric and the polymeric core is uniform in compression and tension.

26. A collector according to claim 17 wherein the core is polymeric and an outer surface of the polymeric core is coated with a UV inhibitor or an externally affixed material such as metal, plastic, fiberglass, or canvas which provides impact resistance and/or durability against harsh weather.

27. A collector according to claim 17 wherein the collector tube is coincident with the rotational axis of the solar collector,

28. A collector according to claim 17 wherein a portion of the cowling overlies an edge of the reflector to aid in securing the reflector to the core.
